(19) United States
(12) Patent Application Publication
(10) Pub. No.: US 2015/0124670 A1
(43) Pub. Date: May 7, 2015

(54) METHOD AND APPARATUS FOR SIMULTANEOUS TRANSMISSION OF DOWNLINK HARQ-ACK AND SR

(71) Applicant: Innovative Technology Lab Co., Ltd., Seoul (KR)

(72) Inventor: Dong Hyun PARK, Seoul (KR)

(21) Appl. No.: 14/530,546

(22) Filed: Oct. 31, 2014

(30) Foreign Application Priority Data
Nov. 1, 2013 (KR) 10-2013-0132483

(51) Int. Cl. H04L 1/18; H04W 76/02; H04L 5/14

(52) U.S. Cl. CPC H04L 1/1887; H04L 1/1893; H04L 5/14; H04W 76/02
USPC 370/281

(57) ABSTRACT

The present disclosure relates to an apparatus and method for supporting a simultaneous transmission of a downlink HARQ-ACK and a SR in a TDD-FDD CA, FDD-TDD CA or a dual connectivity environment.

### CROSS-REFERENCE TO RELATED APPLICATION

This application claims priority from and the benefit of Korean Patent Application No. 10-2013-0132483, filed on Nov. 1, 2013, which is hereby incorporated by reference in its entirety.

### BACKGROUND

1. Field

The present invention relates to wireless communication, and more particularly, to a method and apparatus for simultaneous transmission of a DownLink (DL) Hybrid Automatic Repeat request (HARQ)-Acknowledgement (ACK) and a Scheduling Request (SR) in a wireless communication system that supports a Time Division Duplex (TDD)-Frequency Division Duplex (FDD) joint operation.

2. Discussion of the Background

In a wireless communication system, Hybrid Automatic Repeat reQuest (HARQ) is executed between a transmitter and a receiver. The HARQ is a signal transceiving method that determines whether data received in a physical layer includes an error indisposing for decoding, and requests retransmission when an error occurs. In the process of executing the HARQ, a receiver transmits a Not-Acknowledgement (NACK) through a control channel when an error occurs, and transmits an Acknowledgement (ACK) when an error does not occur. A transmitter may retransmit a data signal when an NACK signal is received. In the case of a DownLink (DL) HARQ, a terminal that receives a Physical Downlink Shared Channel (PDSCH) or a Physical Downlink Control Channel (PDCCH)/Enhanced PDCCH (EPDCCH) that indicates Semi-persistent Scheduling (SPS) release, transmits a HARQ ACK/NACK signal through a Physical Uplink Control Channel (PUCCH) after a predetermined subframe. The HARQ ACK/NACK may be referred to as a HARQ-ACK.

A scheduler of a base station needs to be aware of information associated with an amount of data that is to be transmitted from each terminal in UpLink (UL), so as to allocate an appropriate amount of UL resource. Therefore, the scheduler needs to be at least aware that a terminal has data to be transmitted and scheduling grant is required. This is reported to the base station through a Scheduling Request (SR). The SR is a flag that a terminal transmits for requesting an UL resource from the scheduler. The terminal that requests the UL resource does not have a PUSCH resource and thus, the SR is transmitted on a PUCCH.

The wireless communication system may support a Frequency Division Duplex (FDD) and a Time Division Duplex (TDD). In the FDD, a carrier used for UpLink (UL) transmission and a carrier used for DownLink (DL) transmission exist, respectively, and the UL transmission and the DL transmission simultaneously are executed in a cell. In the TDD, UL transmission and DL transmission are always distinguished based on a time, in a single cell. In the TDD, an identical carrier is used for both the UL transmission and DL transmission and thus, a base station and a terminal repeatedly execute conversion between a transmission mode and a reception mode.

Currently, frequency resources are saturated and various technologies are broadly used in most of the frequency band. For this reason, to satisfy a higher data transmission rate requirement, as a scheme for securing a broadband bandwidth, each scattered band is designed to satisfy basic requirements for operating an independent system and a Carrier Aggregation (CA) has been employed, which binds up a plurality of bands as a single system. In this instance, a band or a carrier that may independently operate is defined as a Component Carrier (CC). Due to the introduction of the CA, ACK/NACK signals corresponding to a plurality of CCs need to be transmitted.

Recently, a TDD-FDD joint operation scheme has been considered that supports a CA and/or dual connectivity of a FDD carrier and a TDD carrier. As the TDD-FDD joint operation is supported, in some cases, it may be required to map a DL HARQ ACK/NACK and an SR to a single PUCCH resource and to simultaneously transmit the same to a base station. However, the standards do not define the simultaneous transmission of the HARQ ACK/NACK and the SR for the TDD-FDD joint operation. There is a desire for a method of simultaneous transmission of the HARQ ACK/NACK and the SR for the TDD-FDD joint operation.

### SUMMARY

Exemplary embodiments of the present invention provide an apparatus and method for supporting a simultaneous transmission of a downlink HARQ-ACK and a SR.

Exemplary embodiments of the present invention provide an apparatus and method for bundling HARQ-ACK signals for multiple serving cells in a carrier aggregation environment or a dual connectivity environment.

An exemplary embodiment of the present invention provides a method of transmitting a Hybrid Automatic Repeat reQuest (HARQ) response from a User Equipment (UE) to a base station, the method including: establishing a Radio Resource Control (RRC) connection with the base station through a first serving cell, the first serving cell supporting a Frequency Division Duplex (FDD) mode; receiving, at the UE, an RRC message through the first serving cell, the RRC message including carrier aggregation (CA) configuration information, the CA configuration information including information of a second serving cell supporting a Time Division Duplex (TDD) mode, and the first serving cell and the second serving cell being aggregated by an FDD-TDD CA scheme; receiving a transport block through the first serving cell; mapping a bit for the HARQ response in association with the received transport block; and transmitting the HARQ response using resources for a Scheduling Request (SR) in a Physical Uplink Control Channel (PUCCH), the PUCCH being transmitted to the base station through the first serving cell.

According to aspects, when a Time Division Duplex (TDD)-Frequency Division Duplex (FDD) Carrier Aggregation (CA) (or dual connectivity) is configured for a terminal, simultaneous transmission of a DL HARQ-ACK and an SR may be effectively executed. According to aspects, the number of transport blocks that a terminal receives on all of the serving cells is counted based on a DL DAI value associated with a FDD cell, and HARQ-ACK bit values may be determined based on the number of transport blocks. In addition, the number of associated DL subframes is detected for each serving cell, the associated DL subframes being included in a set of DL subframes associated with a UL subframe in which a PUCCH to which a HARQ-ACK signal is mapped is transmitted, and HARQ-ACK bit values may be determined based on the number of associated DL subframes.

### BRIEF DESCRIPTION OF THE DRAWINGS

FIG. 1 illustrates a wireless communication system according to embodiments of the present invention.

FIG. 2 illustrates an example of a protocol structure for supporting a multi-carrier system according to embodiments of the present invention.

FIG. 3 illustrates an example of a radio frame structure according to embodiments of the present invention, which is a FDD radio frame structure and a TDD radio frame structure.

FIG. 4 illustrates an example of a FDD-TDD CA according to embodiments of the present invention.

FIG. 5 illustrates examples of capabilities of a terminal for a TDD-FDD CA according to embodiments of the present invention.

FIG. 6 illustrates a method of simultaneous transmission of a HARQ-ACK bit and an SR according to an embodiment of the present invention.

FIG. 7 illustrates an example of a method of simultaneous transmission of a HARQ-ACK and an SR according to a second embodiment of the present invention.

FIG. 8 illustrates another example of a method of simultaneous transmission of a HARQ-ACK and an SR according to the second embodiment of the present invention.

FIG. 9 illustrates another example of a method of simultaneous transmission of a HARQ-ACK and an SR according to the second embodiment of the present invention.

FIG. 10 illustrates another example of a method of simultaneous transmission of a HARQ-ACK and an SR according to the second embodiment of the present invention.

FIG. 11 illustrates another example of a method of simultaneous transmission of a HARQ-ACK and an SR according to the second embodiment of the present invention.

FIG. 12 illustrates an example of a DL HARQ timing associated with a terminal for which a TDD-FDD CA is configured.

FIG. 13 illustrates another example of a method of simultaneous transmission of a HARQ-ACK and an SR according to the present invention.

FIG. 14 is a flowchart of a DL HARQ operation executed between a terminal and a base station for simultaneous transmission of a HARQ-ACK and an SR according to the present invention.

FIG. 15 is a block diagram illustrating a terminal and a base station according to the present invention.

### DETAILED DESCRIPTION OF THE ILLUSTRATED EMBODIMENTS

Exemplary embodiments of the present invention will be described more fully hereinafter with reference to the accompanying drawings, in which exemplary embodiments of the invention are shown. Throughout the drawings and the detailed description, unless otherwise described, the same drawing reference numerals are understood to refer to the same elements, features, and structures. In describing the exemplary embodiments, detailed description on known configurations or functions may be omitted for clarity and conciseness.

Further, the terms, such as first, second, A, B, (a), (b), and the like may be used herein to describe elements in the description herein. The terms are used to distinguish one element from another element. Thus, the terms do not limit the element, an arrangement order, a sequence or the like. It will be understood that when an element is referred to as being “on”, “connected to” or “coupled to” another element, it can be directly on, connected or coupled to the other element or intervening elements may be present. In contrast, when an element is referred to as being “directly on,” “directly connected to” or “directly coupled to” another element, there are no intervening elements present.

Further, the description described herein is related to a wireless communication network, and an operation performed in a wireless communication network may be performed in a process of controlling a network and transmitting data by a system that controls a wireless network, e.g., a base station, or may be performed in a user equipment connected to the wireless communication network.

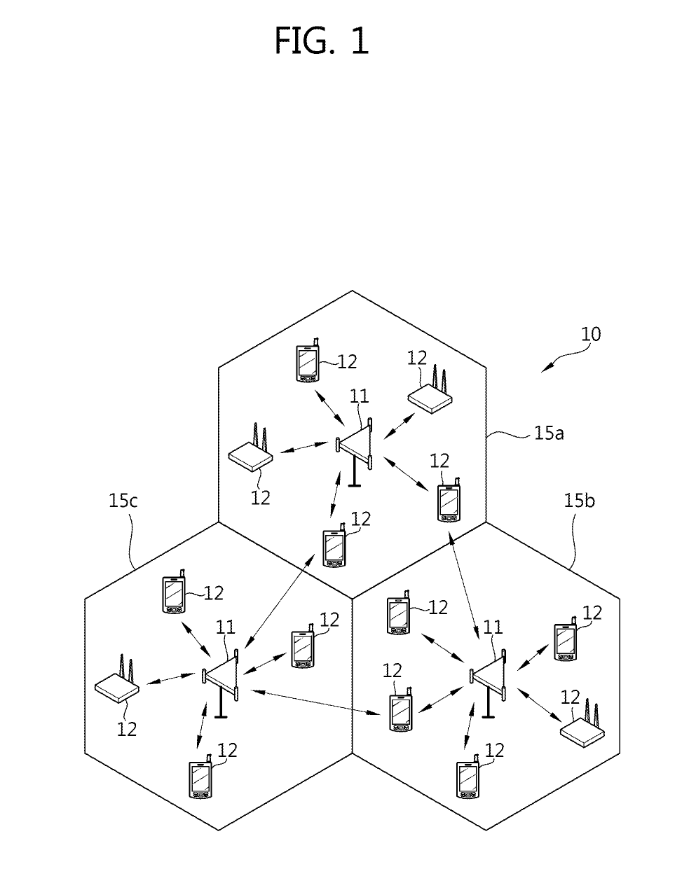

FIG. 1 is a diagram illustrating a wireless communication system according to an exemplary embodiment of the present invention.

According to FIG. 1, a wireless communication system 10 is widely deployed in order to provide diverse telecommunication services, such as voice and packet data. A wireless communication system includes at least one base station 11 (BS). Each BS 11 provides telecommunication service to certain cells 15a, 15b, and 15c. A cell may again be divided into multiple sectors.

User equipment 12 (mobile station, MS) may be located at a certain location or mobile, and may also be referred to as different terms, including UE (user equipment), MT (mobile terminal), UT (user terminal), SS (subscriber station), wireless device, PDA (personal digital assistant), wireless modem, and handheld device. A base station 11 may also be referred to as eNB (evolved-NodeB), BTS (Base Transceiver System), Access Point, femto base station, Home nodeB, and relay. A cell inclusively refers to various coverage areas, such as mega cell, macro cell, micro cell, pico cell, and femto cell.

Hereinafter, the term downlink refers to communication from a base station 11 to a UE 12, and the term uplink refers to communication from a UE 12 to a base station 11. For downlink, a transmitter may be part of a base station 11, and a receiver may be part of a UE 12. For uplink, a transmitter may be part of a UE 12 and a receiver may be part of a base station 11. There is no limitation in the multiple access method applied to a wireless communication system. Diverse methods can be used, including CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, OFDM-CDMA. Uplink transmission and downlink transmission can use either TDD (Time Division Duplex), which uses different time locations for transmissions, or FDD (Frequency Division Duplex), which uses different frequencies for transmissions.

Carrier Aggregation (CA), which is also referred to as spectrum aggregation or bandwidth aggregation, supports multiple carriers. Each individual unit carrier, which is aggregated by carrier aggregation, is referred to as Component Carrier (CC). Each component carrier is defined by bandwidth and center frequency. CA is introduced to support increasing throughput, to prevent cost increase due to the introduction of the wideband radio frequency and to ensure the compatibility with the existing system. For example, if five component carriers are allocated as granularity that has a carrier unit with 20 MHz bandwidth, it can support 100 MHz bandwidth at maximum.

CA may be divided as contiguous carrier aggregation, which is made among continuous CCs, and non-contiguous carrier aggregation, which is made among non-continuous CCs. The number of carriers aggregated between uplink and downlink may be configured differently. It is referred to as symmetric aggregation when there are equal number of downlink CCs and uplink CCs, and it is referred to as asymmetric aggregation when the number of downlink CCs and the number of uplink CCs are not equal.

The size of component carriers (in other words, bandwidth) may be different. For example, if five component carriers are used to form 70 MHz band, 5 MHz component carrier (carrier #0)+20 MHz component carrier (carrier #1)+20 MHz component carrier (carrier #2)+20 MHz component carrier (carrier #3)+5 MHz component carrier (carrier #4) may be aggregated together.

Hereinafter, a multiple carrier system includes the system that supports carrier aggregation. Contiguous CA and/or non-contiguous CA may be used in the multiple carrier system; in addition, both symmetric aggregation and asymmetric aggregation may be used in the multiple carrier system as well. A serving cell may be defined as a component frequency band based on multiple CC system which may be aggregated by CA. A serving cell may include a primary serving cell (PCell) and a secondary serving cell (SCell). A PCell means a serving cell which provides security input and Non-Access Stratum (NAS) mobility information on Radio Resource Control (RRC) establishment or re-establishment state. Depends on the capability of a user equipment, at least one cell may be used together with a PCell to form an aggregation of serving cells, the cell used with a PCell is referred to as an SCell. An aggregation of serving cells which configured for a user equipment may include one PCell, or one PCell together with at least one SCell.

Downlink component carrier corresponding to a PCell refers to Downlink (DL) Primary Component Carrier (PCC), and uplink component carrier corresponding to a PCell refers to Uplink (UL) PCC. In addition, downlink component carrier corresponding to an SCell refers to a DL Secondary Componenent Carrier (SCC), and an uplink component carrier corresponding to an SCell refers to a UL SCC. Only DL CC or UL CC may correspond to a serving cell, or a DL CC and an UL CC together may correspond to a serving cell.

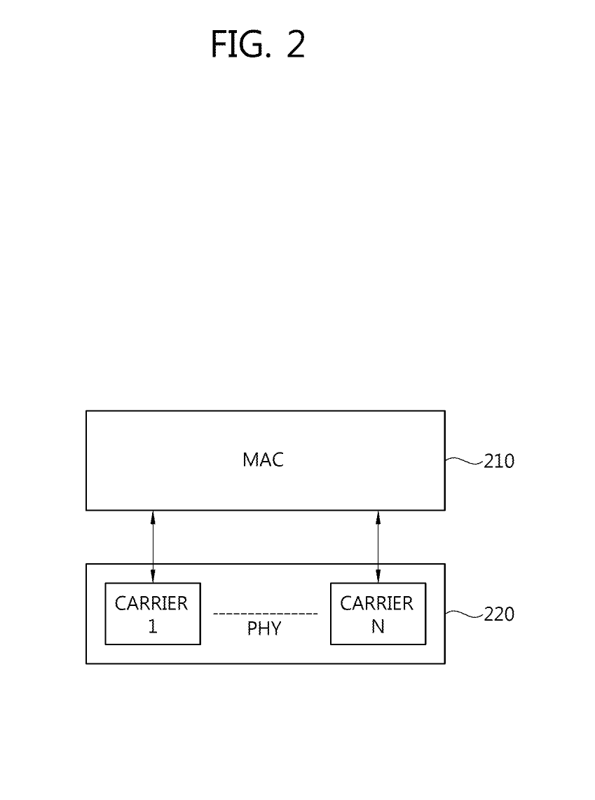

FIG. 2 is a diagram illustrating an example of a protocol structure for supporting a multi-carrier system according to an exemplary embodiment of the present invention.

Referring to FIG. 2, common Medium Access Control (MAC) entity 210 manages physical layer 220 which uses a plurality of carriers. The MAC management message, transmitting through a certain carrier, may be applied to other carriers. That is, the MAC management message is a message which controls other carriers including the certain carrier mentioned above. A physical layer 220 may be operated by the Time Division Duplex (TDD) and/or the Frequency Division Duplex (FDD).

There are some physical control channels used in physical layer 220. As a DL physical channel, a Physical Downlink Control Channel (PDCCH) informs to a UE with regard to resource allocation of a Paging Channel (PCH) and a Downlink Shared Channel (DL-SCH), and a Hybrid Automatic Repeat Request (HARQ) information related to a DL-SCH. The PDCCH may carry uplink grant which informs a resource allocation of uplink transmission to a UE. The DL-SCHO is mapping to a Physical Downlink Shared Channel (PDSCH). A Physical Control Format Indicator Channel (PCFICH), which transmits every sub-frame, informs the number of OFDM symbols used on the PDCCHs to a user equipment. A Physical Hybrid ARQ Indicator Cannel (PHICH), as a DL channel, carries the HARQ ACK/NACK signals as a response to uplink transmission.

A plurality of the PDCCH may be transmitted in the controlled region, and a user equipment can monitor a plurality of the PDCCH. The PDCCH is transmitted on either one Control Channel Element (CCE) or an aggregation of several consecutive CCEs. The CCE is a logical allocation unit used to provide PDCCH with a code rate based on the state of radio channel. The CCE corresponds to a plurality of Resource Element Groups. The format of the PDCCH and the number of available bits for the PDCCH are determined according to the relationship between the number of CCEs and a code rate provided by the CCEs.

Control information carried on the PDCCH is referred to as Downlink Control Information (DCI). The following table 1 shows DCI pursuant to several formats.

TABLE 1

| DCI | |
|---|---|
| Format | Description |
| 0 | Used for PUSCH scheduling in uplink cell |
| 1 | Used for one PDSCH codeword scheduling in one cell |
| 1A | Used for brief scheduling of one PDSCH codeword in |
| | one cell or random access process initialized |
| | by the PDCCH command |
| 1B | Used for a brief scheduling of one PDSCH codeword with |
| | precoding information in one cell |
| 1C | Used for one PDSCH codeword brief scheduling in one cell |
| | or the notification of MCCH change |
| 1D | Used for a brief scheduling of one PDSCH codeword in one |
| | cell including precoding or power offset information |
| 2 | Used for the PDSCH scheduling of the user equipment |
| | configured of spartial multiplexing mode. |
| 2A | Used for the PDSCH scheduling of the user equipment |
| | configured of large delay CDD mode |
| 2B | Used in the transmission mode 8 (a double layer |
| | transmission, etc) |
| 2C | Used in the transmission mode 9 (a multi layer transmission) |
| 2D | Used in the transmission mode 10 (CoMP) |
| 3 | Used for the tramission of TPC commands for PUCCH and |
| | PUSCH including 2-bit power adjustment |
| 3A | Used for the tramission of TPC commands for PUCCH and |
| | PUSCH including single-bit power adjustment |
| 4 | Used for the PUSCH scheduling in the uplink multi-antenna |
| | port transmission cell |

Referring to Table 1, There are DCI formats such as format 0 used for the PUSCH scheduling in uplink cell, format 1 used for one PDSCH codeword scheduling in one cell, format 1A used for compact scheduling of one PDSCH codeword, format 2 used for the PDSCH scheduling in closed-loop spartial multiplexing mode, format 2B used for the PDSCH scheduling in open-loop spartial multiplexing mode, format 2B used in the transmission mode 8, format 2C used in the transmission mode 9, format 2D used in the transmission mode 10, format 3 and 3A used for the uplink tramission of TPC commands for the PUCCH and the PUSCH, and format 4 used for the PUSCH scheduling in the uplink multi-antenna port transmission cell.

Each field of DCI is sequentially mapped to n number of information bits a₀ or aₙ₋₁. For example, the DCI is mapped to a total length of 44 bits of information bits, each field of DCI is mapped sequentially to a₀ or a₄₃. DCI formats 0, 1A, 3, 3A may have the same payload size. DCI format 0, 4 may be referred to as the Uplink grant (UL grant).

As a UL physical channel, Physical Uplink Control Channel (PUCCH) may carry UL controlling information such as ACK(Acknowledgement)/NACK(Non-acknowledgement) or Channel Status Information (CSI) which includes Channel Quality Indicator (CQI), Precoding Matrix Index (PMI), Precoding Type Indicator (PTI) or Rank Indication (RI). The Physical Uplink Shared Channel (PUSCH) carries the Uplink Shared Channel (UL-SCH). The Physical Random Access Channel (PRACH) carries random access preamble.

PUCCH may support various formats. PUCCH may transmit uplink control information having different bit numbers for one subframe according to a modulation scheme. Table 2 shows modulation schemes and the number of bits per subframe according to various PUCCH formats.

TABLE 2

| PUCCH | Modulation | Number of bits per |
|---|---|---|
| format | scheme | subframe, M_{bit} |
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + QPSK | 22 |
| 3 | QPSK | 48 |

PUCCH format 1 is used when a Scheduling Request (SR) exists, that is, in a case of a positive SR. PUCCH format 1a is used for a HARQ-ACK (that is, HARQ ACK/NACK) of 1 bit, or is used for a HARQ-ACK of 1 bit and a positive SR, in a case of the Frequency Division Duplex (FDD). PUCCH format 1b is used for a HARQ-ACK of 2 bits or is used for the HARQ-ACK of 2 bits and a positive SR. In addition, PUCCH format 1b is used for a HARQ-ACK of up to 4 bits with channel selection. This may be applied when a terminal is configured with at least two serving cells, or may be applied when a terminal is configured with a single serving cell in a case of the Time Division Duplex (TDD). PUCCH format 2 is used for CSI reporting that is not multiplexed with a HARQ-ACK. In addition, PUCCH format 2 is used for CSI reporting that is multiplexed with a HARQ-ACK, for an extended Cyclic Prefix (CP). PUCCH format 2a is used for CSI reporting that is multiplexed with a HARQ-ACK of 1 bit for a normal CP. PUCCH format 2b is used for CSI reporting that is multiplexed with a HARQ-ACK of 2 bits for a normal CP. PUCCH format 3 is used for a HARQ-ACK of up to 10 bits for the FDD or a HARQ-ACK of up to 20 bits for the TDD. In addition, PUCCH format 3 is used for 11 bits corresponding to a HARQ-ACK of 10 bits for the FDD and a positive/negative SR of 1 bit, or for 21 bits corresponding to a HARQ-ACK of 20 bits for the TDD and a positive/negative SR of 1 bit. In addition, PUCCH format 3 is used for a HARQ-ACK for a single serving cell, a positive/negative SR of 1 bit, and CSI reporting.

In a Carrier Aggregation (CA) environment, a HARQ-ACK signal with respect to a plurality of DownLink (DL) component carriers may be transmitted through a single UpLink (UL) component carrier. In this instance, an ACK/NACK signal of 1 bit is transmitted for each codeword.

When a base station transmits, to a terminal, a DL grant which is PDSCH scheduling information and the PDSCH through a PDCCH/EPDCCH, the terminal transmits, through a PUCCH at a predetermined timing, a HARQ-ACK with respect to a DL-SCH transport block that is received through the PDSCH. The DL HARQ indicates a process of repeating the above described process, until the base station receives an ACK signal from the terminal. In addition, when a base station transmits a PDCCH/EPDCCH indicating release of a DL Semi-Persistent Scheduling, a terminal transmits a HARQ-ACK with respect to the same through a PUCCH at a predetermined timing. The DL HARQ indicates a process of repeating the above mentioned process until the base station receives an ACK signal from the terminal That is, the HARQ-ACK signal in the DL is transmitted on a PUCCH. A PUCCH format that transmits a HARQ-ACK signal in the DL includes formats 1a/1b/3.

Among the formats, PUCCH format 1b with channel selection may transmit a HARQ-ACK signal (that is, an ACK/NACK signal) of 2 through 4 bits. The channel selection allocates a HARQ-ACK resource for the DL using a table that maps a message to be transmitted and a resource to be used for transmission of the corresponding message and a modulated symbol. The channel selection table may be formed of a plurality of combinations of a resource index and a modulated symbol of an ACK/NACK signal, and may be formed based on the number of bits (M) used for transmitting an ACK/NACK signal. Through the channel selection, a resource required for up to 4-bit signal transmission may be allocated. Accordingly, for an ACK/NACK signal of 4 or less bits, a table is formed based on the number of bits (M) required for transmission of an ACK/NACK signal, and a HARQ-ACK resource may be allocated using the same.

For the FDD, in a case of PUCCH format 1b with the channel selection, when both a HARQ-ACK and an SR are transmitted in an identical subframe, a terminal transmits a HARQ-ACK on its assigned HARQ-ACK PUCCH resource with channel selection for a negative SR transmission, and transmits a single HARQ-ACK bit for each serving cell on its assigned SR PUCCH resource for a positive SR transmission, according to the standards of following Table 3.

TABLE 3
When a PDCCH/EPDCCH that indicates only one transport block or DL
SPS release is detected on a serving cell, a HARQ-ACK bit for the
corresponding serving cell is a HARQ-ACK bit corresponding to the
PDCCH/EPDCCH that indicates the transport block or the DL SPS
release.
When two transport blocks are received on a serving cell, a HARQ-ACK
bit for the corresponding serving cell is generated by spatially
bundling HARQ-ACK bits corresponding to the transport blocks.
When neither a HARQ-ACK response to the PDSCH transmission is
provided, nor a PDCCH/EPDCCH indicating DL SPS release for a
serving cell is detected, a HARQ-ACK bit for the corresponding serving
cell is set as a NACK.

For PUCCH format 1b, b(0) and b(1) bits may be used. A QPSK modulation scheme is used and thus, b(0) and b(1) may be mapped to a modulation symbol d(0) of a single complex value. HARQ-ACK bits for a primary serving cell (PCell) and a secondary serving cell (SCell) may be mapped to b(0) and b(1). In this instance, a HARQ-ACK bit for the PCell is mapped to b(0), and a HARQ-ACK bit for the SCell is mapped to b(1), respectively.

For the TDD, in a case in which PUCCH format 1b with HARQ-ACK bundling, HARQ-ACK multiplexing, or channel selection, is set for a terminal, when both a HARQ-ACK and an SR are transmitted in an identical subframe, the terminal transmits bundled HARQ-ACKs or a multiplexed HARQ-ACK response on its assigned HARQ-ACK PUCCH resources, for a negative SR transmission. For a positive SR, the terminal transmits b(0) and b(1) on its assigned SR PUCCH resource that uses PUCCH format 1b. The values of b(0) and b(1) may be generated based on the number of ACK responses from among

$${N}_{SPS} + {\sum }_{c = 0}^{{N}_{cells}^{DL} - 1} {U}_{DAIc}$$

HARQ-ACK responses. This may have, for example, a mapping relationship as shown in the following Table 4.

TABLE 4

| Number of ACK among multiple $( {N}_{SPS} + {\sum }_{c = 0}^{{N}_{cells}^{DL} - 1} {U}_{DAI , c} )$ HARQ-ACK responses | b(0), b(1) |
|---|---|
| 0 or None (UE detect at least one DL assignment is missed) | 0, 0 |
| 1 | 1, 1 |
| 2 | 1, 0 |
| 3 | 0, 1 |
| 4 | 1, 1 |
| 5 | 1, 0 |
| 6 | 0, 1 |
| 7 | 1, 1 |
| 8 | 1, 0 |
| 9 | 0, 1 |

Here, N_{SPS} denotes a parameter that has a value of 1 in a case of DL SPS transmission in a “a set of DL subframes (hereinafter, a DL subframe set)” associated with a UL subframe for a HARQ response (that is, PDSCH transmission when a PDCCH/EPDCCH indicating allocation of a PDSCH does not exist), and that has a value of 0, for other cases. N^{DL}_{cells} denotes the number of all serving cells, and U_{DAI,c} denotes a total number of PDCCHs/EPDCCHs that a terminal receives on a serving cell c (that is, the number of PDCCHs/EPDCCHs indicating allocation of a PDSCH+the number of PDCCHs/EPDCCHs indicating DL SPS release).

In a case of TDD UL/DL configurations 1 through 6, when Equation 1 and Equation 2 are satisfied, a terminal detects that at least one DL grant is missed.

$$\begin{matrix}{\sum }_{c = 0}^{{N}_{cells}^{DL} - 1} {U}_{DAI , c} > 0 & Equation 1 \\ {V}_{DAI , c}^{DL} \neq ( {U}_{DAI , c} - 1 ) mod 4 + 1 & Equation 2\end{matrix}$$

Here, V^{DL}_{DAL,c} denotes a Downlink Assignment Index (DAI) field value included in a DL DCI format that a terminal receives in the last DL subframe, from among a “DL subframe set” that is associated with a single UL subframe on a serving cell c. (U_{DAI,c}−1) mod 4 denotes a residual obtained after dividing (U_{DAI,c}−1) by 4. Here, the DAI is a message of 2 bits that is transmitted on a PDCCH that transfers a DL DCI format. In the TDD, the DAI indicates an order of DL assignment of a corresponding subframe from among a plurality of DL subframes associated with a single UL subframe, and the value is accumulated on the corresponding DL subframe, and thus, an order of assignment of a subframe is indicated among scheduled DL subframes.

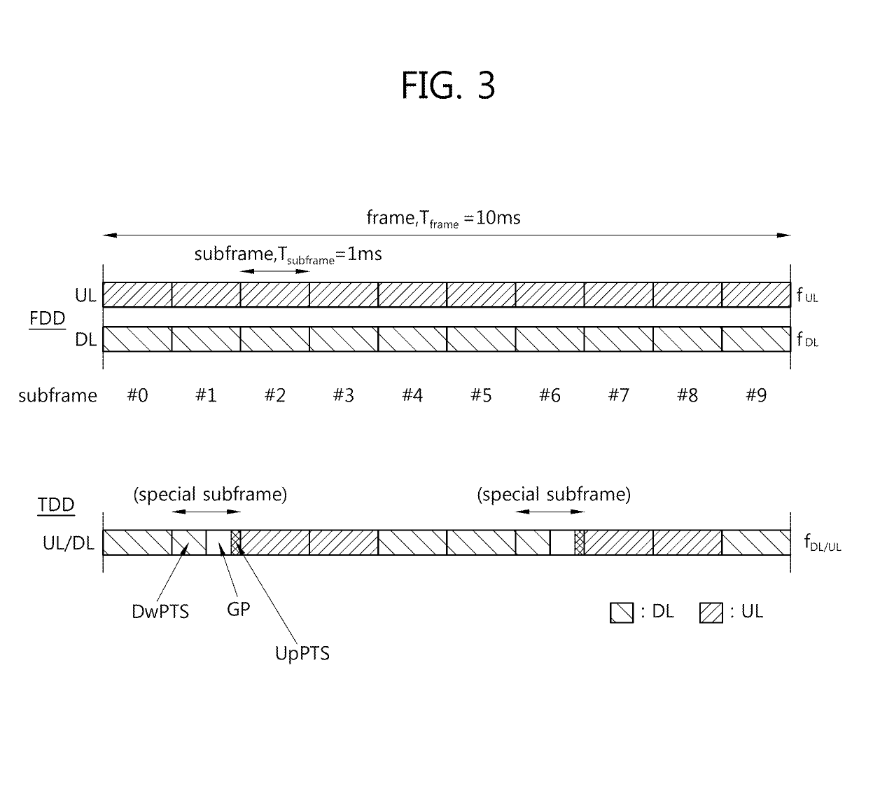

FIG. 3 illustrates an example of a radio frame structure according to embodiments of the present invention. This includes a FDD radio frame structure and a TDD radio frame structure.

Referring to FIG. 3, a single radio frame includes 10 subframes, and a single subframe includes two consecutive slots.

In the FDD, a carrier used for UL transmission and a carrier used for DL transmission exist, respectively, and both the UL transmission and the DL transmission are simultaneously executed in a single cell.

In the TDD, UL transmission and DL transmission are always distinguished based on a time, in a single cell. An identical carrier is used for the UL transmission and the DL transmission and thus, a base station and a terminal repeatedly execute conversion between a transmission mode and a reception mode. The TDD includes a special subframe so as to provide a guard time for converting a mode between transmission and reception. The special subframe may be formed of a Downlink Pilot Time Slot (DwPTS), a Guard Period (GP), and an Uplink Pilot Time Slot (UpPTS), as illustrated in the drawing. The DwPTS is used for initial cell search, synchronization, or channel estimation in a terminal. The UpPTS is used for channel estimation and UL transmission synchronization with a terminal, in a base station. The GP is required to avoid interference between an UL and a DL, and neither UL transmission nor DL transmission occurs during the GP.

Table 5 illustrates an example of a UL-DL configuration of a radio frame. The UL-DL configuration defines a reserved subframe for UL transmission and a reserved subframe for DL transmission. That is, the UL-DL configuration indicates a rule that allocates (or reserves) a UL and a DL in all of the subframes included in a single radio frame.

TABLE 5

| Uplink- | | | | | | | | | | | |
|---|---|---|---|---|---|---|---|---|---|---|---|
| downlink | | | | | | | | | | | |
| config- | Switch-point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In table 5, D denotes a DL subframe, U denotes a UL subframe, and S denotes a special subframe. As shown in Table 5 a subframe 0 and a subframe 5 are always allocated for DL transmission, and a subframe 2 is always allocated for UL transmission. As shown in Table 5, a position and the number of DL subframes and UL subframes in a single radio frame are different for each UL-DL configuration. Through various UL-DL configurations, an amount of resource allocated to UL and DL transmission may be asymmetrically reduced. To avoid severe interference between a DL and a UL among cells, neighboring cells generally have an identical UL-DL configuration.

A point at which a DL is changed to a UL or a point at which a UL is changed to a DL is referred to as a switching point. A switch-point periodicity indicates a period based on which an aspect of conversion between a UL subframe and a DL subframe is equally repeated, which is 5 ms or 10 ms. For example, according to the UL-DL configuration 0, subframes 0 through 4 are changed in order of D->S->U->U->U, and in the same manner, subframes 5 through 9 are changed in order of D->S->U->U->U. One subframe is 1 ms and thus, the switch-point periodicity is 5 ms. That is, the switch-point periodicity is shorter than the length of a single radio frame (10 ms), and the aspect of the conversion is repeated one time in a radio frame.

The UL-DL configuration of Table 5 may be transmitted from a base station to a terminal through system information. The base station may inform the terminal of a change of a UL-DL allocation state of a radio frame, by transmitting only an index of a UL-DL configuration every time the UL-DL configuration is changed. Alternatively, the UL-DL configuration, which is broadcast information, may be control information that is commonly transmitted to all of the terminals included in a cell, through a broadcast channel.

Meanwhile, a TDD-FDD joint operation scheme has been considered that supports a CA and/or dual connectivity of a FDD band or carrier and a TDD band or carrier.

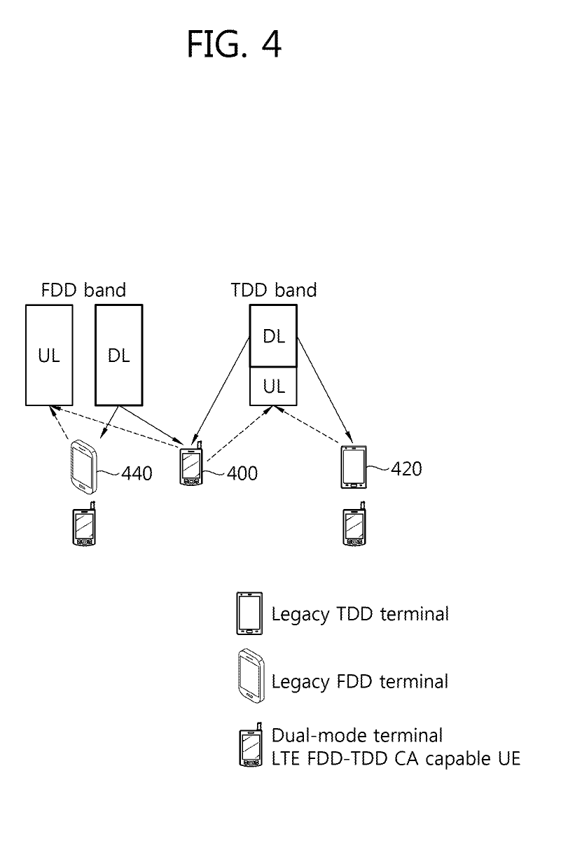

FIG. 4 illustrates an example of a FDD-TDD CA according to embodiments of the present invention;

Referring to FIG. 4, a legacy TDD terminal 420 receives a wireless communication service only through a TDD band, and a legacy FDD terminal 440 receives a wireless communication service only through a FDD band. Conversely, a FDD-TDD CA capable terminal (UE) 400 may receive a wireless communication service through a FDD band and a TDD band, and may also receive a CA-based wireless communication service through a TDD band carrier and a FDD band carrier.

For the above described TDD-FDD CA, for example, the following deployment scenarios may be considered.

For example, a FDD base station and a TDD base station are co-located in an identical place (for example, CA scenarios 1 through 3), or the FDD base station and the TDD base station are not co-located but connected through an ideal backhaul (for example, CA scenario 4).

As another example, the FDD base station and the TDD base station are not co-located and connected through a non-ideal backhaul (for example, small cell scenarios 2a and 2b and a macro-macro scenario).

However, for the TDD-FDD CA, it is desirable that the TDD base station and the FDD base station are connected through a backhaul, and the TDD cell and the FDD cell are synchronized for operation.

In addition, for the TDD-FDD CA, the following prerequisites may be considered.

First, terminals that support the FDD-TDD CA may access a legacy FDD single mode carrier and a legacy TDD single mode carrier.

Second, legacy FDD terminals and terminals that support the TDD-FDD CA may camp on and be connected to a FDD carrier which is a part of a FDD/TDD network that executes a joint operation.

Third, legacy TDD terminals and terminals that support the TDD-FDD CA may camp on and be connected to a TDD carrier which is a part of the FDD/TDD network that executes a joint operation.

Fourth, network architecture enhancement for facilitating the FDD-TDD CA, for example, with respect to the non-ideal backhaul, may be considered. However, keeping the minimal network architecture changes should be considered since it is essential from the perspective of an operator.

In addition, the following capabilities of a terminal may be considered when the terminal supports the TDD-FDD CA.

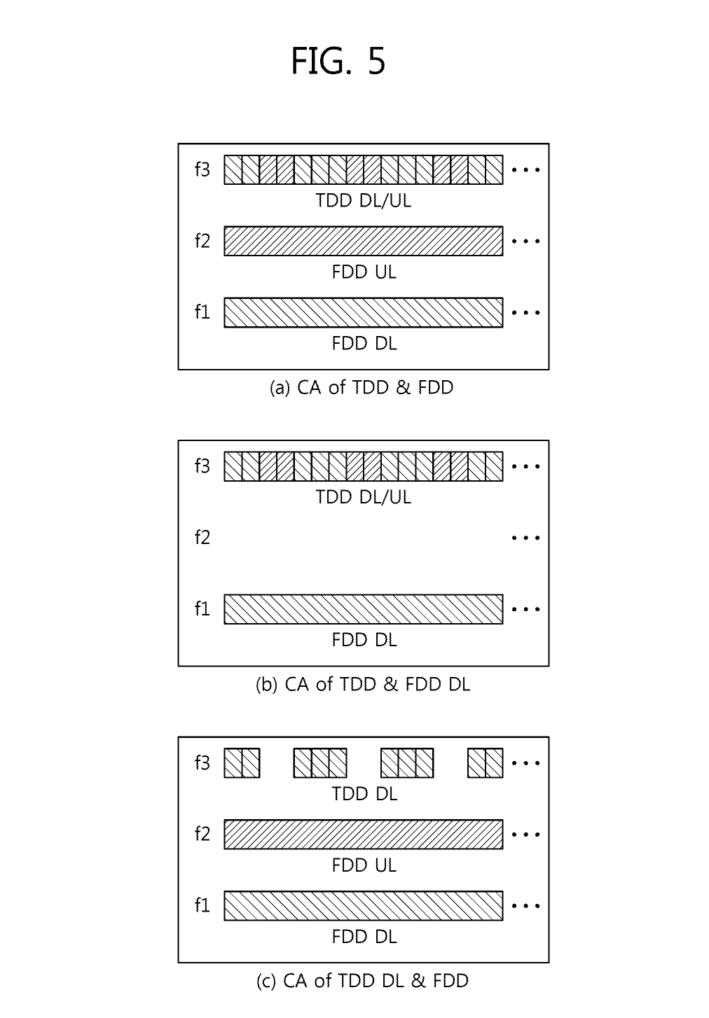

FIG. 5 illustrates examples of capabilities of a terminal for the TDD-FDD CA according to embodiments of the present invention.

Referring FIG. 5, (a) illustrates that a terminal supports a CA of a TDD carrier and a FDD carrier, (b) illustrates that a terminal supports a CA of a TDD carrier and a FDD DL carrier, and (c) illustrates that a terminal supports a CA of a DL subframe of a TDD carrier and a FDD carrier.

As mentioned above, a terminal may support different types of TDD-FDD CA, and also, may perform simultaneous reception (that is, DL aggregation) from FDD and TDD carriers. Second, a terminal may perform simultaneous transmission (that is, UL aggregation) from FDD and TDD carriers. Third, a terminal may perform simultaneous transmission and reception (that is, full duplex) from FDD and TDD carriers.

In the above described TDD-FDD CA, the maximum number of aggregated component carriers may be, for example, 5. In addition, an aggregation of different UL-DL configurations for TDD carriers of different bands may be supported.

In this instance, the FDD-TDD CA capable terminal may support the TDD-FDD DL CA and may not support the TDD-FDD UL CA. The FDD-TDD CA capable terminal may support at least the TDD-FDD DL CA, but may or may not support the TDD-FDD UL CA.

Meanwhile, a terminal may configure a dual connectivity through two or more base stations from among base stations forming at least one serving cell. The dual connectivity is an operation in which a corresponding terminal consumes radio resources provided by at least two different network points (for example, a macro base station and a small base station) in a radio resource control connection (RRC_CONNECTED) mode. In this instance, the at least two different network points may be connected through a non-ideal backhaul. In this instance, one of the at least two different network points may be referred to as a macro base station (or master base station or anchor base station), and the others may be referred to as small base stations (or secondary base stations, or assisting base stations, or slave base stations).

The terminal may support the TDD-FDD joint operation when the CA and/or dual connectivity is configured for the terminal as described above. Hereinafter, although the present invention will be described based on a case in which the CA is configured for a terminal, the present invention is applicable when the dual connectivity is configured for a terminal.

According to the current standards and the current technologies, only for a case in which FDD serving cells are configured for a terminal or a case in which TDD serving cells are configured for a terminal, it is defined that a DL HARQ-ACK and an SR are mapped to a single PUCCH resource and are simultaneously transmitted. However, the simultaneous transmission of the HARQ-ACK and the SR for a case of the TDD-FDD CA, is not defined. To enhance the system performance, mapping of the DL HARQ-ACK and the SR on a single PUCCH resource for simultaneous transmission to a base station needs to be supported for the case of the TDD-FDD CA. Therefore, the present invention provides a method of simultaneous transmission of a HARQ-ACK and an SR for the TDD-FDD CA.

Exemplary embodiments of the present invention provides a scheme of utilizing PUCCH format 1b with channel selection, as an example of the method of simultaneous transmission of the HARQ-ACK (HARQ ACK/NACK) and an SR for the TDD-FDD CA. In this instance, it is assumed that the TDD-FDD CA is configured for a corresponding terminal. When the TDD-FDD CA is configured, PUCCH transmission may be executed on a PCell or an SCell. Hereinafter, it is assumed that the PUCCH transmission is executed on the PCell.

Case 1. TDD(PCell)-FDD(SCell) CA

When a CA configuration for the terminal indicates that the TDD corresponds to a PCell and the FDD corresponds to an SCell, a “DL subframe set” for each serving cell, which is associated with a single UL subframe for PUCCH transmission may be determined based on which DL HARQ timing is applied to the PCell and SCell. The “DL subframe set” may be referred to as a “DL subframe set associated with a UL subframe”.

For the FDD, when a terminal detects a PDSCH transmission for the corresponding terminal from a subframe n−4, the terminal transmits a HARQ response in a subframe n.

For the TDD, when a PDSCH transmission indicated by the detection of a corresponding PDCCH/EPDCCH exists in the subframe n-k or when a PDCCH/EPDCCH indicating DL SPS release exists, the terminal transmits a HARQ response in the subframe n. In this instance, a DL HARQ timing based on a TDD UL-DL configuration may be listed as shown in the following Table 6.

TABLE 6

| UL/DL | | | | | | | | | | |
|---|---|---|---|---|---|---|---|---|---|---|
| config- | Subframe n | | | | | | | | | |
| uration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, | — | — |
| | | | | | | | | 4, 6 | | |
| 3 | — | — | 7, 6, 11 | 6, 5 | 5, 4 | — | — | — | — | — |
| 4 | — | — | 12, 8, | 6, 5, | — | — | — | — | — | — |
| | | | 7, 11 | 4, 7 | | | | | | |
| 5 | — | — | 13, 12, 9, | — | — | — | — | — | — | — |
| | | | 8, 7, 5, 4, | | | | | | | |
| | | | 11, 6 | | | | | | | |
| 6 | — | — | 7 | 7 | 5 | — | — | 7 | 7 | — |

In Table 6, n denotes a subframe number, and a “DL subframe set” associated with a subframe of the corresponding number is determined by K={k₀, k₁, . . . , K_{M-1}}. n-k denotes an index of a subframe that is k subframes before from an n^{th} subframe, which indicates a DL subframe associated with a current subframe. The associated DL subframe indicates a subframe that delivers a PDSCH or a DL SPS release command which is the basis of the determination on an ACK/NACK signal. M denotes the number of elements included in a set K defined in table 5, and indicates the number of DL subframes associated with the n^{th} subframe.

In addition, when a TDD-TDD CA is configured for a terminal, a DL HARQ timing is determined based on the following criterion.

For the TDD, when a terminal is configured with one or more serving cells, at least two serving cells have different UL-DL configurations, and a corresponding serving cell is a PCell, a UL-DL configuration of the corresponding PCell is a DL reference UL-DL configuration for the PCell. Here, the DL reference UL-DL configuration indicates a UL-DL configuration used as a reference for a DL HARQ timing of a corresponding serving cell.

Meanwhile, for the TDD, when a terminal is configured with two or more serving cells, at least two serving cells have different UL-DL configurations, and a corresponding serving cell is an SCell, a DL reference UL-DL configuration for the corresponding SCell is as shown in the following Table 7.

TABLE 7

| Set | (Primary cell UL/DL configuration, | DL-reference UL/ |
|---|---|---|
| # | Secondary cell UL/DL configuration) | DL configuration |
| Set 1 | (0, 0) | 0 |
| | (1, 0), (1, 1), (1, 6) | 1 |
| | (2, 0), (2, 2), (2, 1), (2, 6) | 2 |
| | (3, 0), (3, 3), (3, 6) | 3 |
| | (4, 0), (4, 1), (4, 3), (4, 4), (4, 6) | 4 |
| | (5, 0), (5, 1), (5, 2), (5, 3), | 5 |
| | (5, 4), (5, 5), (5, 6) | |
| | (6, 0), (6, 6) | 6 |
| Set 2 | (0, 1), (6, 1) | 1 |
| | (0, 2), (1, 2), (6, 2) | 2 |
| | (0, 3), (6, 3) | 3 |
| | (0, 4), (1, 4), (3, 4), (6, 4) | 4 |
| | (0, 5), (1, 5), (2, 5), (3, 5), | 5 |
| | (4, 5), (6, 5) | |
| | (0, 6) | 6 |
| Set 3 | (3, 1), (1, 3) | 4 |
| | (3, 2), (4, 2), (2, 3), (2, 4) | 5 |
| Set 4 | (0, 1), (0, 2), (0, 3), (0, 4), | 0 |
| | (0, 5), (0, 6) | |
| | (1, 2), (1, 4), (1, 5) | 1 |
| | (2, 5) | 2 |
| | (3, 4), (3, 5) | 3 |
| | (4, 5) | 4 |
| | (6, 1), (6, 2), (6, 3), (6, 4), (6, 5) | 6 |
| Set 5 | (1, 3) | 1 |
| | (2, 3), (2, 4) | 2 |
| | (3, 1), (3, 2) | 3 |
| | (4, 2) | 4 |

In Table 7, based on a pair of a PCell UL-DL configuration and an SCell UL-DL configuration, the DL reference UL-DL configuration for the SCell may be indicated.

For example, when the pair of the PCell UL-DL configuration and the SCell UL-DL configuration of Table 7 belongs to Set 1, the DL reference UL-DL configuration for the SCell applies a DL HARQ timing based on the DL reference Ul-DL configuration for Set 1. In this instance, it is irrespective of a scheduling method.

Alternatively, in a case in which self-scheduling is set for a terminal, when the pair of the PCell UL-DL configuration and the SCell UL-DL configuration belongs to Set 2 or Set 3, a DL reference UL-DL configuration of Set 2 or Set 3 is used. Here, when self-scheduling is set for the terminal, it indicates that the terminal is set to not monitor a PDCCH/EPDCCH of another serving cell for scheduling of a corresponding serving cell.

Alternatively, in a case in which cross-carrier scheduling is set for a terminal, when the pair of the PCell UL-DL configuration and the SCell UL-DL configuration belongs to Set 4 or Set 5, a DL reference UL-DL configuration of Set 4 or Set 5 is used. Here, when cross-carrier scheduling is set for the terminal, it indicates that the terminal is set to monitor a PDCCH/EPDCCH of another serving cell for scheduling of a corresponding serving cell.

That is, the DL reference UL-DL configuration of Set 1 is applied when a corresponding pair is satisfied, irrespective of whether a Carrier Indicator Field (CIF) indicating a carrier associated with scheduling is configured. Conversely, Set 2 and Set 3 are applied to only a terminal for which the CIF is not configured, and Set 4 and Set 5 are applied to only a terminal for which the CIF is configured.

Meanwhile, a method of transmission of a HARQ-ACK bit and an SR, used in the TDD-TDD CA, determines whether a corresponding terminal misses at least one

PDCH/EPDCCH, using a DAI value (i.e. V^{DL}_{DAI,c}) within DL DCI formats (for example, 1/1A/1B/1D/2/2A/2B/2C/and 2D).

However, the TDD (PCell)-FDD (SCell) CA does not have a method of simultaneous transmission of a HARQ-ACK and an SR, and a “DL subframe set” is needed even in the FDD so as to draw a DL HARQ timing (for example, a UL-DL configuration-based on a PCell, a reference UL-DL configuration based on, a new DL HARQ timing, and the like) that may be applied to the TDD-FDD CA by taking into consideration self scheduling/cross-carrier scheduling and the like. Therefore, the present invention provides a method of effectively supporting simultaneous transmission of a HARQ-ACK and an SR by adding a new DL DAI value V^{DL}_{DAI,c} to DL DCI formats indicating DL data (that is, a PDSCH) transmitted in the FDD when a PCell corresponds to the TDD and an SCell corresponds to the FDD. In this instance, a DL DAI value may be added to DL DCI formats transmitted in the FDD with respect to all terminals for which the TDD (PCell)-FDD (SCell) CA is configured, irrespective of a HARQ-ACK transmission method (PUCCH format 1b with channel selection or PUCCH format 3).

### First Embodiment

The first embodiment adds a DL DAI value to a DL DCI format transmitted on a FDD serving cell, as described above. In this instance, a method of simultaneous transmission of a HARQ-ACK bit and an SR used for a single carrier TDD and the TDD-TDD CA, may be utilized for the TDD (PCell)-FDD (SCell) CA. In particular, a terminal counts the number of DL HARQ “ACK” responses of all of the serving cells, determines b(0) and b(1) based on Table 4, and transmits the same on an SR PUCCH resource.

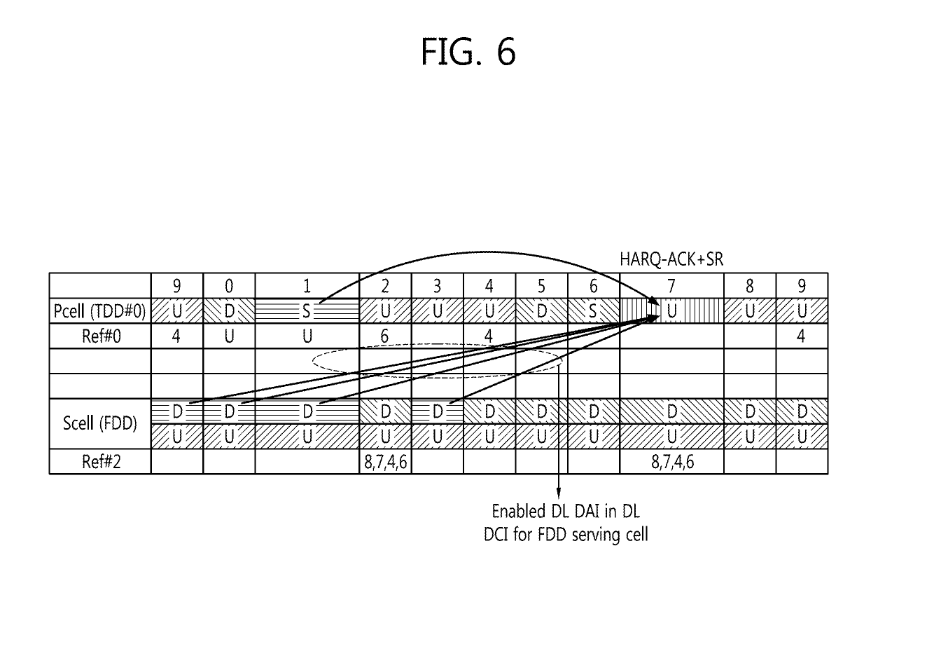

FIG. 6 illustrates a method of simultaneous transmission of a HARQ-ACK bit and an SR according to an embodiment of the present invention. FIG. 6 assumes that a DL reference configuration associated with a PCell is #0 and a DL reference configuration associated with an SCell is #2.

Referring to FIG. 6, a DL DAI value is included in a DL DCI format that indicates PDSCH transmission on a FDD serving cell, and is transmitted with a HARQ-ACK bit in a subframe 7 of the PCell through an SR PUCCH. In this instance, for the PCell, a “DL subframe set” associated with the subframe 7 is {1}. For the SCell, a “DL subframe set” associated with the subframe 7 is {9,0,1,3}.

In particular, a DL DAI value V^{DL}_{DAL,c} of a DL DCI (that is, a DL DCI in n-k^{th} DL subframe indicated by kₘ which is the smallest value among K={k₀, k₁, . . . , K_{M-1}} of Table 6, a DL DCI in a subframe 3 in the example of FIG. 6) that a terminal receives most recently among a “DL subframe set” determined based on a DL HARQ timing set for transmission of a HARQ ACK bit for the FDD serving cell, is compared with the number of DL DCIs (that is, PDCCHs/EPDCCHs) that the terminal receives from each serving cell. Based on the above, when

$${\sum }_{c = 0}^{{N}_{cells}^{DL} - 1} {U}_{DAI , c} > 0$$

and V^{DL}_{DAI,c}≠(U_{DAI,c}−1) mod 4+1 in association with a serving cell c, the terminal detects that at least one DL DCI allocation is missed. In this instance, the terminal determines that b(0)=0 and b(1)=0 with reference to Table 4, and transmits a HARQ response to a base station. Accordingly, the terminal may detect that at least one DL grant (that is, DL DCI) is missed, and may report the same to the base station. As a matter of course, the terminal counts the number of “ACKs” with respect to PDSCHs received on all of the serving cells, that is,

$${N}_{SPS} + {\sum }_{c = 0}^{{N}_{cells}^{DL} - 1} {U}_{DAI , c} ,$$

matches the value to Table 4 so as to detect b(0) and b(1) values, transmits the detected b(0) and b(1) values on an SR PUCCH resource, and executes simultaneous transmission of a HARQ-ACK and an SR.

The first embodiment minimizes the impact on the standards and may execute simultaneous transmission of a HARQ-ACK bit and an SR for the TDD-FDD CA.

### Second Embodiment

The second embodiment includes a DL DAI value V^{DL}_{DAI,c} in a DL DCI for indicating a PDSCH transmitted on a FDD serving cell, like the first embodiment, and further considers a method for additional enhancement of performance based on the number of DL subframes included in a “DL subframe set” of a PCell and the number of DL subframes included in a “DL subframe set” of an SCell. This reflects that an applied DL HARQ timing may be different between a TDD serving cell and a FDD serving cell, and each serving cell may have a different “DL subframe set associated with a UL subframe”.

A combination of the number of DL subframes included in a “DL subframe set” of a PCell and the number of DL subframes included in a “DL subframe set” of an SCell, in association with a single UL subframe, that is, (Mp:Ms), may be expressed by the following Table 8. Here, Mp denotes the number of DL subframes included in the DL subframe set of the PCell, and Ms denote the number of DL subframes included in the DL subframe set of the SCell.

TABLE 8

| Combination | (Mp:Ms) |
|---|---|
| Combination 1 | (1:0), (2:0), (3:0), (4:0) |
| Combination 2 | (1:1) |
| Combination 3 | (2:2), (3:3), (4:4) |

In table 8, in the combination 1, (1:0) indicates that Mp is 1 and Ms is 0, (2:0) indicates that Mp is 2 and Ms is 0, (3:0) indicates Mp is 3 and Ms is 0, and (4:0) indicates that Mp is 4 and Ms is 0. Although Table 8 lists the combination 1 as (1:0), (2:0), (3:0), and (4:0), a case of (0:1), (0:2), (0:3), and (0:4) may be included in the combination 1. That is, the combination 1 indicates a case of (x:0) or (0:x). Here, x is a random value. Alternatively, the combination 1 may be expressed as a case of min(Mp:Ms)=0.

In the combination 2, (1:1) indicates a case in which both Mp and Ms are 1.

In the combination 3, (2:2) indicates that both Mp and Ms are 2, (3:3) indicates that both Mp and Ms are 3, and (4:4) indicates that both Mp and Ms are 4.

Meanwhile, the method described in the first embodiment may be applied to other cases excluding the combinations 1 through 3.

The case of (1:0) (or (0:1)) of the combination 1

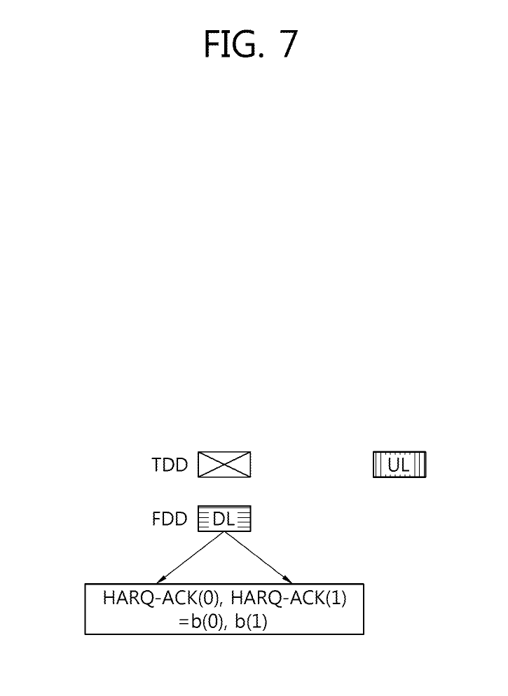

FIG. 7 illustrates an example of a method of simultaneous transmission of a HARQ-ACK and an SR according to a second embodiment of the present invention. FIG. 7 illustrates a case in which a DL subframe that is included in a “DL subframe set associated with a UL subframe” of a PCell corresponding to a TDD cell does not exist, a single DL subframe that is included in a “DL subframe set associated with a UL subframe” of an SCell corresponding to a FDD cell exists, and two transport blocks are transmitted to a terminal Here, the UL subframe indicates a UL subframe (of the PCell), for PUCCH transmission for a HARQ response, as described earlier.

Referring to FIG. 7, the two transport blocks transmitted to the terminal correspond to a HARQ-ACK(0) and a HARQ-ACK(1), respectively. The HARQ-ACK(0) corresponds to b(0), and the HARQ-ACK(1) corresponds to b(1). Here, a HARQ-ACK indicates a HARQ ACK/NACK signal, as described earlier. In this instance, b(0) and b(1) values are determined without separately applying a bundling scheme or an ACK counting scheme, and a HARQ-ACK and an SR are transmitted to a base station by transmitting the b(0) and b(1) values in a UL subframe on an SR PUCCH resource.

The standards for operations associated with the above example will be described in the following table.

TABLE 9
When a PDCCH/EPDCCH indicating only one transport block or DL SPS
release is detected on a single serving cell, and the remaining serving
cell does not have a DL subframe included in a “DL subframe set
associated with a UL subframe”, a HARQ-ACK bit for the serving
cell in which the one transport block is transmitted is a HARQ-ACK
bit corresponding to the PDCCH/EPDCCH indicating the transport block
or the DL SPS release.
In this instance, only one HARQ-ACK bit exists and thus, a corresponding
HARQ-ACK signal may be transmitted on an SR PUCCH resource using
PUCCH format 1a.
When two transport blocks are received on a single serving cell, and the
remaining serving cell does not have a DL subframe included in a “DL
subframe set associated with a UL subframe”, HARQ-ACK bits for a
serving cell in which the two transport blocks are transmitted may be
mapped to b(0) and b(1).
In this instance, two HARQ-ACK bits exist and thus, a corresponding
HARQ-ACK signal may be transmitted on an SR PUCCH resource using
PUCCH format 1b.
When a PDCCH/EPDCCH that indicates PDSCH transmission or DL SPS
release for a serving cell is not detected by a terminal, a HARQ ACK
bit for the corresponding serving cell is set as a NACK.
Also, HARQ-ACK bits for a serving cell in which a PDCCH/EPDCCH
indicating PDSCH transmission or DL SPS release is transmitted, may
be mapped to b(0) and b(1), respectively.

(2) The Case of (2:0) (or (0:2)) of the Combination 1

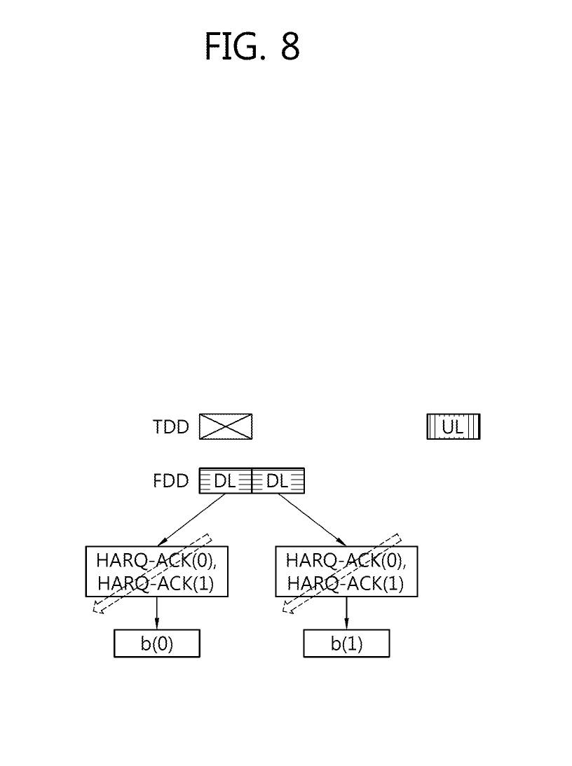

FIG. 8 illustrates another example of a method of simultaneous transmission of a HARQ-ACK and an SR according to the second embodiment of the present invention. FIG. 8 illustrates a case in which a DL subframe that is included in a “DL subframe set associated with a UL subframe” of a PCell corresponding to a TDD cell does not exist, two DL subframes that are included in a “DL subframe set associated with a UL subframe” of an SCell corresponding to a FDD cell exist, and two transport blocks are transmitted to a terminal for each DL subframe.

Referring to FIG. 8, the two transport blocks transmitted to the terminal for each DL subframe correspond to a HARQ-ACK(0) and a HARQ-ACK(1), respectively. In this instance, a HARQ-ACK bit is determined by applying spatial bundling for each DL subframe. Here, the spatial bundling indicates a method of generating a single HARQ-ACK bit by executing a logical AND operation with respect to the HARQ-ACK (0) and the HARQ-ACK (1) respectively corresponding to the two transport blocks when two transport blocks are transmitted in a single DL subframe of a single serving cell. In this instance, a “b” value is determined for each DL subframe, and b(0) and b(1) values may be obtained for the two DL subframes. a HARQ-ACK and an SR are simultaneously transmitted to a base station by transmitting the values on an SR PUCCH resource in a UL subframe.

The standards for operations associated with the above example will be described in the following table.

TABLE 10
When a PDCCH/EPDCCH that indicates only one transport block or DL
SPS release is detected on a single serving cell, a HARQ-ACK bit for the
serving cell in which the single transport block is transmitted, is a
HARQ-ACK bit corresponding to the PDCCH/EPDCCH that indicates the
transport block or the DL SPS release. (In this instance, spatial bundling
is not executed)
When two transport blocks are received in a single serving cell, a HARQ-
ACK bit for the corresponding serving cell is generated by performing
spatial bundling for each DL subframe.
When a PDCCH/EPDCCH that indicates PDSCH transmission or DL SPS
release for a serving cell is not detected by a terminal, a HARQ ACK
bit for the corresponding serving cell is set as a NACK.
Also, HARQ-ACK bits for the two DL subframes included in the “DL
subframe set associated with a UL subframe” and in which a PDCCH/
EPDCCH indicating PDSCH transmission or DL SPS release is trans-
mitted, may be mapped to b(0) and b(1), respectively.

(3) The Case of (3:0), (4:0) (or (0:3), (0:4)) of the Combination 1

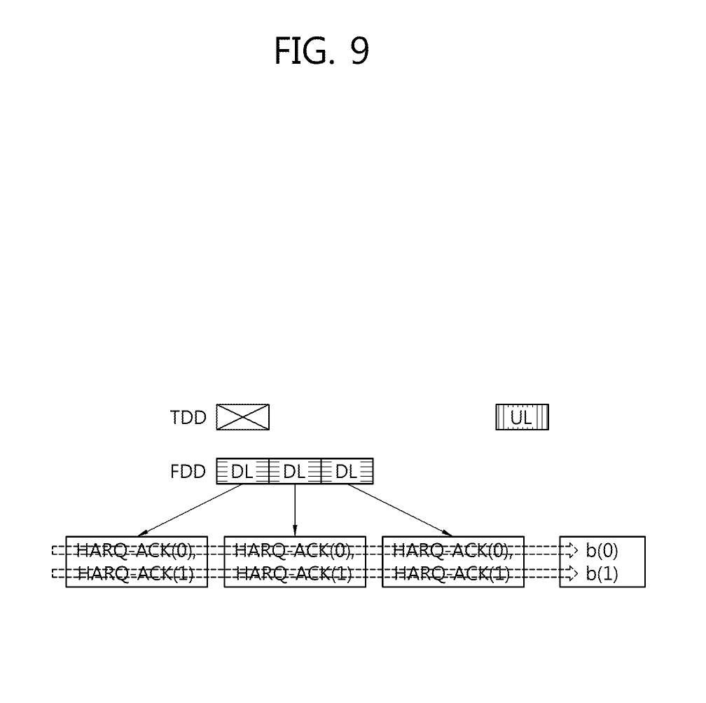

FIG. 9 illustrates another example of a method of simultaneous transmission of a HARQ-ACK and an SR according to the second embodiment of the present invention. FIG. 9 illustrates a case in which a DL subframe that is included in a “DL subframe set associated with a UL subframe” of a PCell corresponding to a TDD cell does not exist, three DL subframes that are included in a “DL subframe set associated with a UL subframe” of an SCell corresponding to a FDD cell exist, and two transport blocks are transmitted to a terminal for each DL subframe.

Referring to FIG. 9, the two transport blocks transmitted to the terminal for each DL subframe correspond to a HARQ-ACK(0) and a HARQ-ACK(1), respectively. In this instance, b(0) and b(1) values are obtained by applying A/N bundling (that is, a logical AND operation) with respect to HARQ-ACK signals generated based on an identical codeword for the DL subframes. For example, the b(0) value is obtained by executing A/N bundling on the HARQ-ACK(0)s of the DL subframes in the time domain, and the b(1) value is obtained by executing A/N bundling on the HARQ-ACK(1)s of the DL subframes in the time domain. A HARQ-ACK and an SR are simultaneously transmitted to a base station by transmitting the b(0) and b (1) values on an SR PUCCH resource in a UL subframe.

The standards for operations associated with the above example will be described in the following table.

TABLE 11
When a PDCCH/EPDCCH that indicates only one transport block or DL
SPS release is detected on a serving cell, a HARQ-ACK bit for the serving
cell in which the single transport block is transmitted, is a HARQ-ACK
bit corresponding to the PDCCH/EPDCCH that indicates the transport
block or the DL SPS release.
When two transport blocks are received on a single serving cell, HARQ-
ACK bits for the corresponding serving cell correspond to the two trans-
port block, respectively.
The HARQ-ACK bits are generated by executing a logical AND operation
(A/N bundling) on a “DL subframe set associated with a UL subframe”
for each codeword of each subframe.
Also, HARQ-ACK bits for 3 or 4 DL subframes that are included in a “DL
subframe set associated with a UL subframe” and in which a PDCCH/
EPDCCH indicating PDSCH transmission or DL SPS release is trans-
mitted, may be mapped to b(0) (1 transport) or b(0) and b(1) (2 trans-
port), based on the number of transports (the number of codewords).
Therefore, the HARQ-ACK bit(s) may be transmitted on an SR PUCCH
resource using PUCCH format 1a or 1b, based on the number of trans-
ports (=the number of codewords).

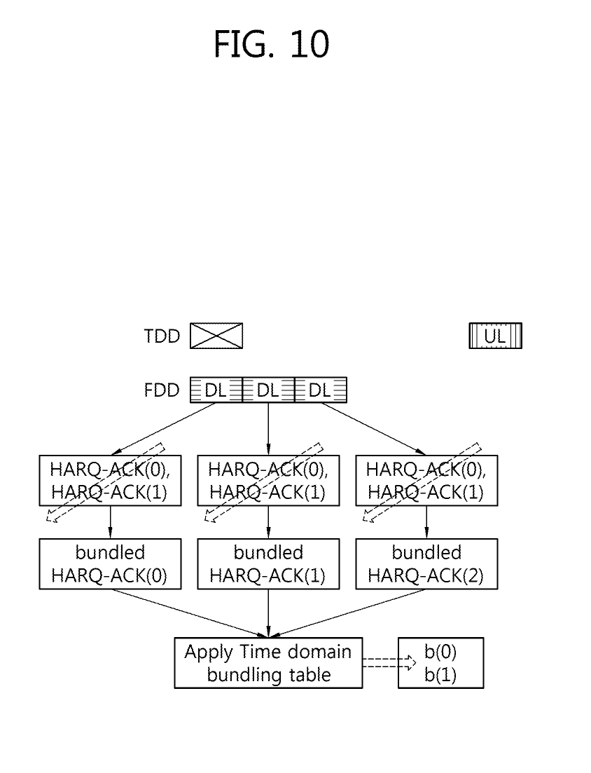

FIG. 10 illustrates another example of a method of simultaneous transmission of a HARQ-ACK and an SR according to the second embodiment of the present invention. FIG. 10 is a case of applying spatial bundling, unlike the example of FIG. 9.

Referring to FIG. 10, the two transport blocks transmitted to the terminal for each DL subframe correspond to a HARQ-ACK(0) and a HARQ-ACK(1), respectively. In this instance, bundled HARQ-ACKs (herein, a bundled HARQ-ACK(0), a bundled HARQ-ACK(1), and a bundled HARQ-ACK(2)) are obtained by applying spatial bundling for each DL subframe. Subsequently, b(0) and b(1) values are obtained with respect to the bundled HARQ-ACKs, using the time domain bundling table of Table 12 or Table 13. A HARQ-ACK and an SR are simultaneously transmitted to a base station by transmitting the b(0) and b(1) values on an SR PUCCH resource in a UL subframe.

TABLE 12
HARQ-ACK state mapping for M = 3 case

| HARQ(0), HARQ(1), HARQ(2) | Mapped |
|---|---|
| ACK, ACK, ACK | ACK, ACK |
| ACK, ACK, NACK/DTX | NACK/DTX, ACK |
| ACK, NACK/DTX, any | ACK, NACK/DTX |
| NACK/DTX, any, any | NACK/DTX, NACK/DTX |

TABLE 13
HARQ-ACK state mapping for M = 4 case

| HARQ-ACK(0), HARQ-ACK(1), | |
|---|---|
| HARQ-ACK(2), HARQ-ACK(3) | Mapped state |
| ‘DTX, any, any, any’ or no | DTX, DTX |
| DL assignment is received. | |
| ACK, DTX, DTX, DTX | ACK, NACK |
| ACK, ACK, NACK/DTX, any | NACK, ACK |
| ACK, ACK, ACK, NACK/DTX | ACK, ACK |
| ACK, ACK, ACK, ACK | ACK, NACK |
| ‘NACK, any, any, any’ or ‘ACK, DTX/NACK, | NACK, NACK |
| any, any except for ‘ACK, DTX, DTX, DTX’ | |

Table 12 may be applied to the case of (3:0) (or (0:3)) of the combination 1, and Table 13 may be applied to the case of (4:0) (or (0:4)) of the combination 1. That is, table 12 corresponds to a case in which the number of DL subframes included in a “DL subframe set associated with a UL subframe” is 3 (M=3), and Table 13 corresponds to a case in which the number of DL subframes included in a “DL subframe set associated with a UL subframe” is 4 (M=4). The bundled HARQ-ACK (0), the bundled HARQ-ACK (1), and the bundled HARQ-ACK (2) according to the present invention may be matched to a HARQ(0), a HARQ(1), and a HARQ(2), according to Table 12. Also, the bundled HARQ-ACK(0), the bundled HARQ-ACK(1), the bundled HARQ-ACK(2), and the bundled HARQ-ACK(3) according to the present invention may be matched to a HARQ(0), a HARQ(1), a HARQ(2), and a HARQ(3), according to Table 13.

The standards for operations associated with the above example will be described in the following table.

TABLE 14
When a PDCCH/EPDCCH that indicates only one transport block or DL
SPS release is detected on a single serving cell, a HARQ-ACK bit for the
serving cell in which the single transport block is transmitted, is a
HARQ-ACK bit corresponding to the PDCCH/EPDCCH that indicates the
transport block or the DL SPS release. (In this instance, spatial bundling
is not executed)
When two transport blocks are received on a single serving cell, HARQ-
ACK bits for the corresponding serving cell correspond to the two trans-
port block, respectively.
When two transport blocks are transmitted, the HARQ-ACK bits are
generated using the bundled HARQ-ACK bits generated by spatial
bundling, based on the time domain bundling table of Table 12 or Table
13. Conversely, when a single transport block is transmitted, the HARQ-
ACK bits are generated based on the time domain bundling table of
Table 12 or Table 13, without executing spatial bundling.
Also, HARQ-ACK bits that are generated, through the above described
process, for 3 or 4 DL subframes included in the “DL subframe set asso-
ciated with a UL subframe” and in which a PDCCH/EPDCCH indicating
PDSCH transmission or DL SPS release is transmitted, may be mapped to
b(0) and b(1), respectively. Therefore, the HARQ-ACK bit(s) may be
transmitted on an SR PUCCH resource using PUCCH format 1b, irrespec-
tive of the number of transports (=the number of codewords).

(4) The Case of (1:1) of the Combination 2

In the case of (1:1) of the combination 2 (that is, Mp=1 and Sp=1), an existing method that is applied to the FDD-FDD CA may be reused.

(5) The Case of (2:2) (3:3), or (4:4) of the Combination 3

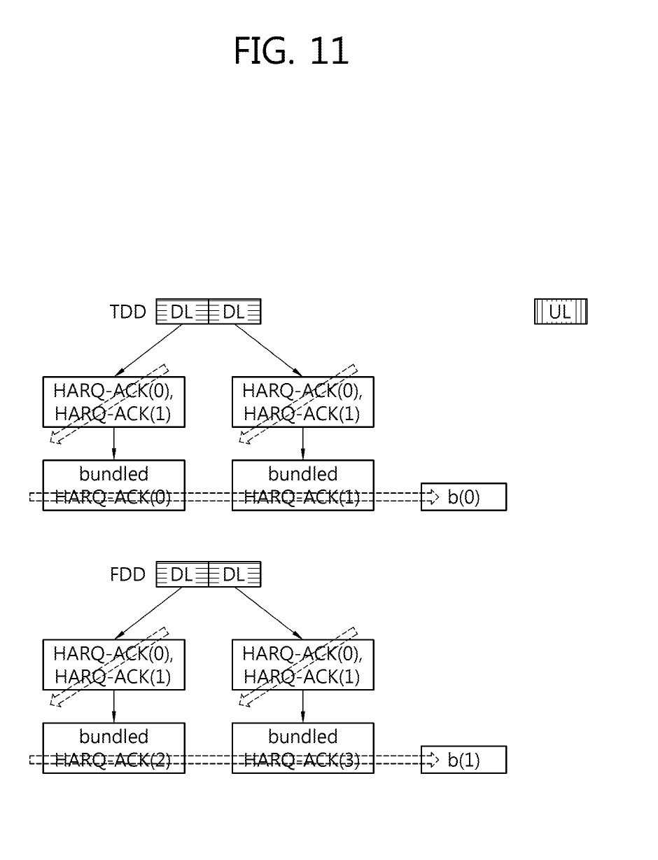

FIG. 11 illustrates another example of a method of simultaneous transmission of a HARQ-ACK and an SR according to the second embodiment of the present invention. FIG. 11 illustrates a case in which two DL subframes that are included in a “DL subframe set associated with a UL subframe” of a PCell corresponding to a TDD cell exist, two DL subframes that are included in a “DL subframe set associated with a UL subframe” of an SCell corresponding to a FDD cell exist, and two transport blocks are transmitted to a terminal for each DL subframe.

Referring to FIG. 11, the two transport blocks transmitted to the terminal for each DL subframe on each TDD and FDD cell correspond to a HARQ-ACK(0) and a HARQ-ACK(1), respectively. In this instance, bundled HARQ-ACKs (herein, a bundled HARQ-ACK(0) and a bundled HARQ-ACK(1)), are obtained by applying spatial bundling for each DL subframe of each serving cell. Subsequently, b(0) and b(1) values are obtained by executing a logical AND operation on the bundled HARQ-ACKs in the time domain for each serving cell. In this instance, the b(0) value is obtained by executing a logical AND operation on the bundled HARQ-ACK(0) and bundled HARQ-ACK(1) of the PCell, in the time domain, and the b(1) value is obtained by executing a logical AND operation on the bundled HARQ-ACK(0) and the bundled HARQ-ACK(1) of the SCell in the time domain. For example, in a case in which a logical AND operation is executed with respect to bundled HARQ-ACK(0) and bundled HARQ-ACK(1) of a serving cell, when both the bundled HARQ-ACK(0) and the bundled HARQ-ACK(1) indicate “ACK” (or 1), “ACK” (or 1) is detected as the b(0) value. When at least one of the bundled HARQ-ACK(0) and the bundled HARQ-ACK(1) indicates “NACK”(or 0), “NACK” (or 0) is detected as the b(0) value.

A HARQ-ACK and an SR are simultaneously transmitted to a base station by transmitting the b(0) and b(1) values on an SR PUCCH resource in a UL subframe.

The standards for operations associated with the above example will be described in the following table.

TABLE 15
When a PDCCH/EPDCCH that indicates only one transport block or DL
SPS release is detected on a single serving cell, a HARQ-ACK bit for
the serving cell in which the single transport block is transmitted,
is a HARQ-ACK bit corresponding to the PDCCH/EPDCCH that indicates
the transport block or the DL SPS release. (In this instance, spatial
bundling is not executed)
When two transport blocks are received on a single serving cell, HARQ-
ACK bits for the corresponding serving cell correspond to the two
transport blocks, respectively.
The HARQ-ACK bits are generated by executing a logical AND operation
(A/N bundling) on a “DL subframe set associated with a UL subframe”
for each codeword of each subframe.
Also, HARQ-ACK bits for 2, 3, or 4 DL subframes included in a “DL
subframe set associated with a UL subframe” may be mapped to b(0)
and b(1), respectively, for each two serving cells in which a PDCCH/
EPDCCH indicating PDSCH transmission or DL SPS release is trans-
mitted. Therefore, the HARQ-ACK bit(s) may be transmitted on an SR
PUCCH resource using PUCCH format 1b, irrespective of the number of
transports (=the number of codewords).

Case 2. FDD(PCell)-TDD(SCell) CA

A terminal is configured with CA configuration for indicating a FDD corresponds to a PCell and a TDD corresponds to an SCell, a DL HARQ timing identical to an existing FDD DL HARQ timing may be applied for both the PCell and the SCell.

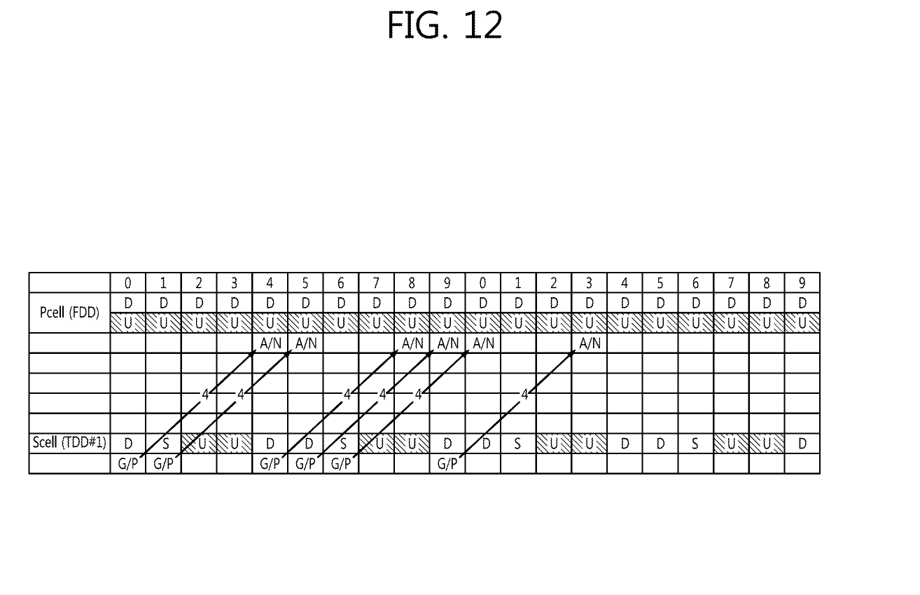

FIG. 12 illustrates an example of a DL HARQ timing associated with a terminal for which a TDD-FDD CA is configured. FIG. 12 corresponds to a case in which a PCell is configured as the FDD, and an SCell is configured as TDD UL/DL configuration 1. FIG. 12 is an example that applies a FDD DL HARQ timing.

Referring to FIG. 12, G denotes DL grant, P denotes a PDSCH, and A/N denotes HARQ-ACK reporting. When a PUCCH transmission serving cell is a FDD cell, as shown in FIG. 12, a DL HARQ timing associated with a PDSCH transmitted on other aggregated serving cells may use a DL HARQ timing applied to the FDD cell, irrespective of whether an SCell corresponds to the TDD or the FDD, and the TDD UL/DL configuration of the SCell. That is, when PDSCH transmission for the corresponding terminal is detected in a subframe n−4 of the PCell and/or SCell, a HARQ response is transmitted in a subframe n of the PCell.

In this instance, it may be construed that the two serving cells have an identical “DL subframe set associated with a UL subframe”. In this instance, particularly, a DAI field is not needed for DL DCI formats for indicating PDSCH transmission of a TDD serving cell.

Therefore, in this instance, the DL DAI value in the DL DCI format for indicating PDSCH transmission in the TDD serving cell may be disabled.

Meanwhile, the following method may be further applied to optimize simultaneous transmission of a HARQ-ACK and an SR.

First, in FDD(PCell)-TDD(SCell) CA, a considerable combination of a “DL subframe set associated with a UL subframe”, in other words, a combination of the number of DL subframes included in a “DL subframe set” of a PCell and the number of DL subframes included in a “DL subframe set” of an SCell, that is, (Mp:Ms), may be expressed by the following Table 16. Here, Mp denotes the number of DL subframes sets of the PCell, and Ms denotes the number of DL subframe sets of the SCell.

TABLE 16

| Combination | (Mp:Ms) |
|---|---|
| Combination 1 | (1:1) |
| Combination 2 | (1:0) |

Table 16, (1:1) of the combination 1 indicates that Mp is 1 and Ms is 1, and (1:0) of the combination 2 indicates that Mp is 1 and Ms is 0.

The combination 1 reuses the method of simultaneous transmission of a HARQ-ACK and an SR utilized for the existing FDD-FDD CA, as described earlier.

However, in the combination 2, that is, the case of (1:0), Ms is 0 and thus, the case corresponds to a UL subframe in which a TDD SCell fails to receive a PDSCH. That is, subframes 2, 3, 7, and 8 of FIG. 12 correspond to the combination 2. In this instance, the following method may be applied for simultaneous transmission of a HARQ-ACK and an SR.

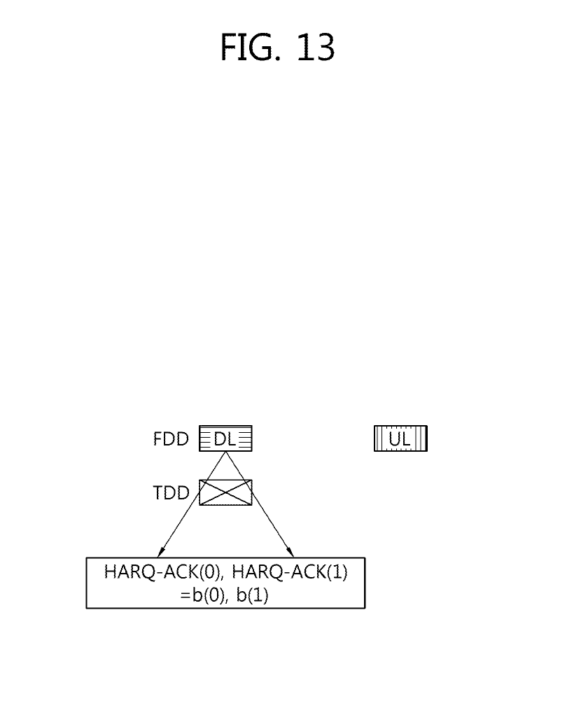

FIG. 13 illustrates another example of a method of simultaneous transmission of a HARQ-ACK and an SR according to the present invention. FIG. 13 illustrates a case in which a single DL subframe that is included in a “DL subframe set associated with a UL subframe” of a PCell corresponding to a FDD cell exists, a DL subframe that is included in a “DL subframe set associated with a UL subframe” of an SCell corresponding to a TDD cell does not exist, and two transport blocks are transmitted to a terminal Here, the UL subframe indicates a UL subframe (of the PCell) for PUCCH transmission for a HARQ response, as described earlier.

Referring to FIG. 13, the two transport blocks transmitted to the terminal through the FDD PCell correspond to a HARQ-ACK(0) and a HARQ-ACK(1), respectively. The HARQ-ACK(0) corresponds to b(0), and the HARQ-ACK(1) corresponds to b(1). When two transport blocks transmitted only through the FDD PCell, b(0) and b(1) values are determined without separately applying a bundling or ACK counting scheme, and a HARQ-ACK and an SR are transmitted to a base station by transmitting the b(0) and b(1) values in a UL subframe on an SR PUCCH resource.

The standards for operations associated with the above example will be described in the following table.

TABLE 17
When a PDCCH/EPDCCH indicating only one transport block or DL SPS
release is detected on a single serving cell, and the remaining serving
cell does not have a DL subframe included in a “DL subframe set
associated with a UL subframe”, a HARQ-ACK bit for a serving cell
in which the one transport block is transmitted is a HARQ-ACK bit
corresponding to the PDCCH/EPDCCH indicating the transport block
or the DL SPS release.
In this instance, only one HARQ-ACK bit exists and thus, a corresponding
HARQ-ACK signal may be transmitted on an SR PUCCH resource using
PUCCH format 1a.
When two transport blocks are received on a single serving cell, and the
remaining serving cell does not have a DL subframe included in a “DL
subframe set associated with a UL subframe”, HARQ-ACK bits for the
serving cell in which the two transport blocks may be mapped to b(0) and
b(1).
In this instance, two HARQ-ACK bits exist and thus, a corresponding
HARQ-ACK signal may be transmitted on an SR PUCCH resource using
PUCCH format 1b.
When a PDCCH/EPDCCH that indicates PDSCH transmission or DL SPS
release for a serving cell is not detected by a terminal, a HARQ ACK
bit for the corresponding serving cell is set as a NACK.
Also, HARQ-ACK bits for the serving cell in which a PDCCH/EPDCCH
indicating PDSCH transmission or DL SPS release, may be mapped to
b(0) and b(1), respectively.

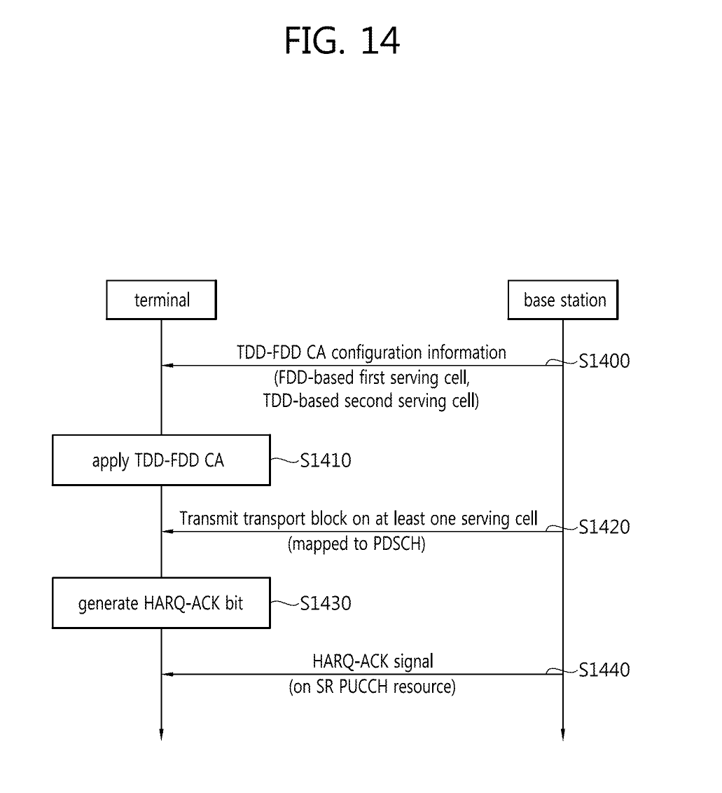

FIG. 14 is a flowchart of a DL HARQ operation executed between a terminal and a base station for simultaneous transmission of a HARQ-ACK and an SR according to the present invention. FIG. 14 describes a case in which a carrier aggregation (CA) of a TDD-based serving cell and a FDD-based serving cell is configured for a terminal, and the present invention may be applied to a case in which dual connectivity is configured, in addition to the CA.

Referring to FIG. 14, a base station transmits, to a terminal, TDD-FDD CA configuration information indicating CA of a TDD-based first serving cell and a FDD-based second serving cell, in operation S1400. The TDD-FDD CA configuration information may include TDD UL-DL configuration information of the TDD-based first serving cell. The base station transmits, to the terminal, the TDD-FDD CA configuration information through RRC signaling.

The terminal applies the CA of the TDD-based first serving cell and the FDD-based second serving cell, based on the TDD-FDD CA configuration information, in operation S1410. In this instance, the first serving cell may be a PCell and the second serving cell may be an SCell. Alternatively, the first serving cell may be an SCell, and the second serving cell may be a PCell.

The base station maps at least one transport block to a PDSCH, and transmits the same to the terminal in at least one DL subframe on at least one serving cell, in operation S1420. In this instance, the PDSCH to which the at least one transport block is mapped, may be indicated by a PDCCH/EPDCCH. The transport block is mapped to a single codeword, and at least one HARQ-ACK signal may correspond to each transport block. When the first serving cell is the PCell, a DL DAI value may be added to a DL DCI format included in a PDCCH/EPDDCH for the second serving cell and may be transmitted to the terminal. When the second serving cell is the PCell, a DL DAI value may be disabled in a DL DCI format included in a PDCCH/EPDDCH for the first serving cell.

The terminal generates a HARQ-ACK signal indicating successful or unsuccessful reception of at least one transport block that is received in the at least one DL subframe on the at least one serving cell, in operation S1430.

For example, when the first serving cell is the PCell and a DL DAI value for the FDD-based second serving cell is received by being added in the DL DCI format, the terminal counts the number of transport blocks that the terminal receives in all of the serving cells based on the received DL DAI value, as described in the first embodiment, and determines b(0) and b(1) which are HARQ-ACK bits with reference to the described Table 4, and generates a HARQ-ACK signal based on the same. Also, when Equation 1 and Equation 2 are satisfied based on the most recently received DL DAI value V^{DL}_{DAte}, the terminal detects that at least one DL grant is missed and sets b(0)=0 and b(1)=0.

As another example, when the first serving cell is the PCell and a DL DAI value for the FDD-based second serving cell is received by being added in a DL DCI format, HARQ-ACK bit b(0) and b(1) may be set based on the combination of (Mp:Ms) of Table 8, as described in the second embodiment. For example, in operation S1440, when the number of associated DL subframes included in a “DL subframe set associated with a UL subframe” in which a PUCCH is transmitted to the base station, is M, spatial bundling for each associated DL subframe, logical AND operation in the time domain, and/or time domain bundling, and the like are executed for each serving cell based on a combination of Mp (the number of associated DL subframes of the PCell) and MS (the number of associated DL subframes of the SCell), and thus, a b(0) value or b(0) and b(1) values may be detected or set. In this instance, the b(0) and b(1) values may be detected or set based on the standards described in Table 9, 10, 11, 14, or 15. In addition, the time domain bundling may be executed by referring to the above described Tables 13 and 14.

As another example, when the second serving cell is the PCell, the terminal may set HARQ-ACK bit b(0) and b(1), based on the combination of (Mp:Ms) of Table 16. In this instance, the b(0) and b(1) values may be detected or set based on the standards described in Table 17.

The terminal maps the HARQ-ACK signal to an SR PUCCH resource of the PCell and transmits the same in a DL HARQ timing detected based on the DL subframe in which a transport block is received and a TDD/FDD configuration of the serving cells, in operation S1440. The terminal may execute simultaneous transmission of a HARQ-ACK and a (positive) SR by transmitting the b(0) and b(1) values on an SR PUCCH resource in a UL subframe. In this instance, the SR PUCCH resource includes, for example, PUCCH format 1a, 1b, or PUCCH format 1b with channel selection.

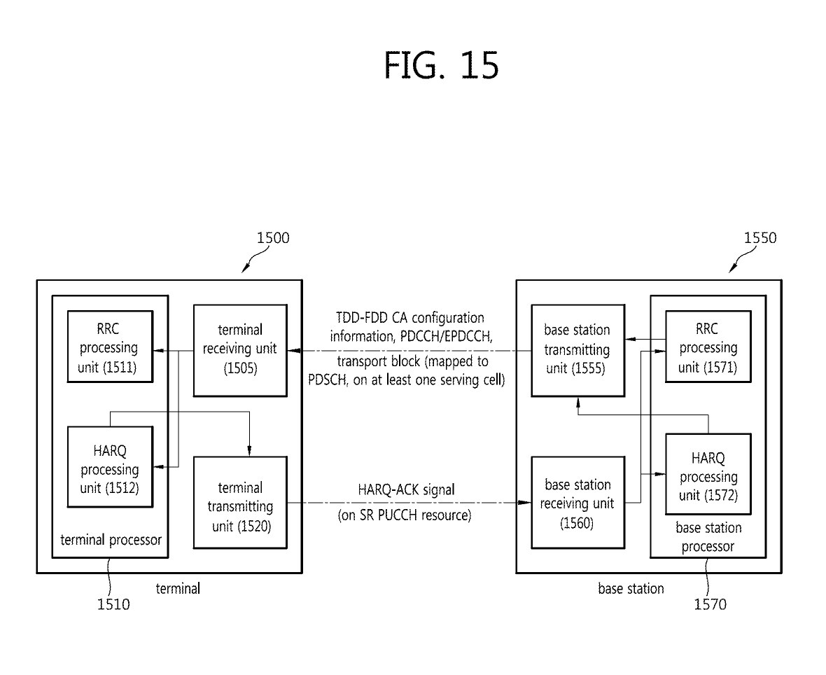

FIG. 15 is a block diagram illustrating a terminal and a base station according to the present invention.

Referring to FIG. 15, a terminal 1500 includes a terminal receiving unit 1505, a terminal processor 1510, and a terminal transmitting unit 1520. The terminal processor 1510 may further include an RRC processing unit 1511 and a HARQ processing unit 1512.

The terminal receiving unit 1505 receives TDD-FDD CA configuration information indicating a CA of a TDD-based first serving cell and a FDD-based second serving cell, from a base station 1550, and transfers the same to the RRC processing unit 1511. In addition, the terminal receiving unit 1505 receives a transport block mapped to a PDSCH, on at least one serving cell. In this instance, the terminal receiving unit 1505 may receive one or a plurality of transport blocks in at least one DL subframe.

The terminal receiving unit 1505 receives a PDCCH/EPDCCH that indicates the PDSCH. In addition, when the first serving cell is a PCell, the terminal receiving unit 1505 may receive a DL DAI value included in a DL DCI format of the PDCCH/EPDCCH for the second serving cell. In addition, when the second serving cell is the PCell, the terminal receiving unit 1505 may receive a disabled DL DAI value included in a DL DCI format of the PDCCH/EPDCCH for the first serving cell.

The RRC processing unit 1511 applies the CA configuration of the TDD-based first serving cell and the FDD-based second serving cell to the terminal 1500, based on the TDD-FDD CA configuration information. In this instance, the RRC processing unit 1511 configures the first serving cell as the PCell and configures the second serving cell as the SCell, for the terminal 1500, based on the TDD-FDD CA configuration information. Alternatively, the RRC processing unit 1511 configures the second serving cell as the PCell and configures the first serving cell as the SCell, for the terminal 1500, based on the TDD-FDD CA configuration information.

The HARQ processing unit 1512 determines whether reception of at least one transport block is successful or unsuccessful, which is received in at least one DL subframe on at least one serving cell, and generates an ACK/NACK signal based on a result of the determination.

For example, when the first serving cell is the PCell and the DL DAI value for the FDD-based second serving cell is received by being added in the DL DCI format, the HARQ processing unit 1512 counts the number of transport blocks that the terminal successfully receives (ACK) in all of the serving cells based on the received DL DAI value, as described in the first embodiment, and determines b(0) and b(1) which are HARQ-ACK bits with reference to the described Table 4, and generates a HARQ-ACK signal based on the same. Also, when Equation 1 and Equation 2 are satisfied based on a DL DAI value V^{DL}_{DAI,c} that is most recently received by the terminal receiving unit 1505, the HARQ processing unit 1512 detects that at least one DL grant is missed and sets b(0)=0 and b(1)=0.

As another example, when the first serving cell is the PCell and the DL DAI value for the FDD-based second serving is received by being added in the DL DCI format, the HARQ processing unit 1512 set HARQ-ACK bit b(0) and b(1) based on the combination of (Mp:Ms) of Table 8, as described in the second embodiment. In this instance, the HARQ processing unit 1512 may detect or set b(0) and b(1) values based on the standards described in Table 9, 10, 11, 14, or 15. In addition, the HARQ processing unit 1512 may refer to the above described Tables 13 and 14, for executing time domain bundling.

As another example, when the second serving cell is the PCell, the HARQ processing unit 1512 may set HARQ-ACK bit b(0) and b(1), based on the combination of (Mp:Ms) of Table 16. In this instance, the HARQ processing unit 1512 may detect or set b(0) and b(1) values based on the standards described in Table 17.

In addition, the HARQ processing unit 1512 may determine a DL HARQ timing based on the DL subframe in which the terminal receiving unit 1505 receives the transport block and the TDD-FDD configuration of the serving cells that is applied by the RRC processing unit 1511.

The terminal transmitting unit 1520 may transmit, to the base station 1550, a HARQ-ACK signal in the DL HARQ timing determined by the HARQ processing unit 1512, on an SR PUCCH resource of the PCell.

The base station 1550 includes a base station transmitting unit 1555, a base station receiving unit 1560, and a base station processor 1570. The base station processor 1570 may further include an RRC processing unit 1571 and a HARQ processing unit 1572.

The RRC processing unit 1571 generates the TDD-FDD CA configuration information, and transfers the same to the base station transmitting unit 1555.

The base station transmitting unit 1555 may transmit the TDD-FDD CA configuration information to the terminal 1500 through an RRC signaling. In this instance, the RRC signaling may be an RRC connection reconfiguration message. Also, the base station transmitting unit 1555 may transmit, to the terminal 1500, a transport block mapped to a PDSCH on at least one serving cell, based on the TDD UL-DL configuration of the first serving cell and the FDD configuration of the second serving cell. In this instance, the base station transmitting unit 1555 may transmit, to the terminal 1500, a plurality of transport blocks in at least one DL subframe.

The base station receiving unit 1560 may receive, from the terminal 1500, a HARQ-ACK signal in a UL subframe of the PCell, based on the DL HARQ timing. The HARQ-ACK signal may be received by being mapped to an SR PUCCH resource of the PCell. In this instance, as the SR PUCCH resource, for example, PUCCH format 1b with channel selection may be used.

The HARQ processing unit 1572 may detect or determine a DL HARQ timing associated with the at least one transport block. In this instance, the HARQ processing unit 1572 may detect the DL HARQ timing based on the TDD-FDD CA configuration information.

When the base station receiving unit 1560 receives the HARQ-ACK signal on the SR PUCCH resource, the HARQ processing unit 1572 may determine that a HARQ-ACK and a positive SR for requesting an UL resource are simultaneously received, and may determine whether to execute UL grant on the terminal 1500, based on the SR.

In addition, the HARQ processing unit 1572 executes a HARQ operation based on the HARQ-ACK signal received by the base station receiving unit 1560. For example, when the HARQ-ACK signal indicates ACK, the HARQ processing unit 1572 transmits a new transport block to the base station transmitting unit 1555, and the base station transmitting unit 1555 transmits the new transport block to the terminal 1500. Conversely, when the HARQ-ACK signal indicates NACK, the HARQ processing unit 1572 transmits, to the base station transmitting unit 1555, transport blocks mapped to a DL subframe associated with a UL subframe in which the HARQ-ACK signal is transmitted, and the base station transmitting unit 1555 retransmits the transport blocks to the terminal 1500.

A terminal, e.g., a user equipment may establish a Radio Resource Control (RRC) connection with a base station through a primary serving cell. The primary serving cell may support a Frequency Division Duplex (FDD) mode. The terminal may receive an RRC message through the primary serving cell, and the RRC message includes carrier aggregation (CA) configuration information. The CA configuration information includes information of a secondary serving cell (SCell) supporting a Time Division Duplex (TDD) mode, and the primary serving cell and the secondary serving cell may be aggregated by an FDD-TDD CA scheme. The terminal may receive a transport block through the primary serving cell and map a bit for the HARQ response in association with the received transport block. Then, the terminal may transmit the HARQ response using resources for a Scheduling Request (SR) in a Physical Uplink Control Channel (PUCCH), and the PUCCH may be transmitted to the base station through the primary serving cell.

The terminal may detect one transport block or two transport blocks in a subframe having an index n (subframe n) of the primary serving cell. The subframe n may be configured with an uplink subframe for the secondary serving cell when the secondary serving cell is a TDD cell. The bit for the HARQ response may be transmitted by the terminal using the resources for the SR in the PUCCH in a subframe n+4.

One bit for the HARQ response is transmitted by the resources for the SR in the PUCCH in the subframe n+4 if one transport block is detected from the subframe n of the primary serving cell. Further, two bits for the HARQ response are transmitted by the resources for the SR in the PUCCH in the subframe n+4 if two transport blocks are detected from the subframe n of the primary serving cell. If two transport blocks are transmitted through the primary serving cell, the bit for the HARQ response is determined without applying a bundling.

The terminal may determine the bit for the HARQ response based on the number of downlink subframes of the primary serving cell associated with an uplink subframe for transmitting the HARQ response for the transport block and the number of downlink subframes of the secondary serving cell associated with the uplink subframe for transmitting the HARQ response for the transport block.

The terminal may detect a Physical Downlink Control Channel (PDCCH) or an Enhanced PDCCH through the primary serving cell, and the PDCCH or the EPDCCH indicate a downlink Semi-persistent scheduling (SPS) release or the transport block of a Physical Downlink Shared Channel (PDSCH). Here, the UE transmits the HARQ response and the SR with a PUCCH format 1a/1b through the primary serving cell.

Further, the HARQ response for the primary serving cell through which the one transport block is detected is one bit for the HARQ response corresponding to the PDCCH or the EPDCCH indicating the transport block or the downlink SPS release, if the PDCCH or the EPDCCH indicating one transport block or a downlink SPS release is detected from the primary serving cell and the secondary serving cell does not include a downlink subframe included in a downlink subframe set associated with an uplink frame.

Further, the HARQ response may be transmitted by using a PUCCH format 1a through the primary serving cell.

The HARQ response for the first cell through which the two transport blocks are detected is two bits for the HARQ response corresponding to b(0) and b(1), respectively, and the bits for the HARQ response are transmitted using a PUCCH format 1b, if two transport blocks are detected through the primary serving cell and the secondary serving cell does not include a downlink subframe, which belongs to a downlink subframe set associated with an uplink subframe.

The HARQ response for the primary serving cell is set as a negative acknowledgement (NACK), if neither the PDSCH transmission nor the PDCCH or the EPDCCH indicating the downlink SPS release is detected by the UE.

While the present invention has been shown and described in connection with the embodiments, it will be apparent to those skilled in the art that modifications and variations can be made without departing from the spirit and scope of the invention as defined by the appended claims. Thus, the present invention is not limited to the foregoing embodiments and may include all the embodiments within the scope of the appended claims.

What is claimed is:

1. A method of transmitting a Hybrid Automatic Repeat reQuest (HARQ) response from a User Equipment (UE) to a base station, the method comprising:
establishing a Radio Resource Control (RRC) connection with the base station through a first serving cell, the first serving cell supporting a Frequency Division Duplex (FDD) mode;
receiving, at the UE, an RRC message through the first serving cell, the RRC message comprising carrier aggregation (CA) configuration information, the CA configuration information comprising information of a second serving cell supporting a Time Division Duplex (TDD) mode, and the first serving cell and the second serving cell being aggregated by an FDD-TDD CA scheme;
receiving a transport block through the first serving cell;
mapping a bit for the HARQ response in association with the received transport block; and
transmitting the HARQ response using resources for a Scheduling Request (SR) in a Physical Uplink Control Channel (PUCCH), the PUCCH being transmitted to the base station through the first serving cell.

2. The method of claim 1, wherein the reception of the transport block comprises:
detecting one or two transport blocks in a subframe n of the first serving cell,
wherein the subframe n is configured with an uplink subframe for the second serving cell.

3. The method of claim 1, wherein the transmission of the HARQ response comprises:
transmitting the bit for the HARQ response using the resources for the SR in the PUCCH in a subframe n+4.

4. The method of claim 3, wherein one bit for the HARQ response is transmitted by the resources for the SR in the PUCCH in the subframe n+4 if one transport block is detected from the subframe n of the first serving cell.

5. The method of claim 3, wherein two bits for the HARQ response are transmitted by the resources for the SR in the PUCCH in the subframe n+4 if two transport blocks are detected from the subframe n of the first serving cell.

6. The method of claim 5, wherein, if two transport blocks are transmitted through the first serving cell, the bit for the HARQ response is determined without applying a bundling.

7. The method of claim 1, wherein the mapping comprises:
determining the bit for the HARQ response based on the number of downlink subframes of the first serving cell associated with an uplink subframe for transmitting the HARQ response for the transport block and the number of downlink subframes of the second serving cell associated with the uplink subframe for transmitting the HARQ response for the transport block.

8. The method of claim 1, wherein the transmission of the HARQ response comprises:
detecting a Physical Downlink Control Channel (PDCCH) or an Enhanced PDCCH through the first serving cell, the PDCCH or the EPDCCH indicating a downlink Semi-persistent scheduling (SPS) release or the transport block of a Physical Downlink Shared Channel (PDSCH),
wherein the UE transmits the HARQ response and the SR with a PUCCH format 1a/1b through the first serving cell.

9. The method of claim 8, wherein the HARQ response for the first serving cell through which the one transport block is detected is one bit for the HARQ response corresponding to the PDCCH or the EPDCCH indicating the transport block or the downlink SPS release, if the PDCCH or the EPDCCH indicating one transport block or a downlink SPS release is detected from the first serving cell and the second serving cell does not include a downlink subframe included in a downlink subframe set associated with an uplink frame.

10. The method of claim 9, wherein the HARQ response is transmitted by using a PUCCH format 1a through the first serving cell.

11. The method of claim 9, wherein the HARQ response for the first cell through which the two transport blocks are detected is two bits for the HARQ response corresponding to b(0) and b(1), respectively and the bits for the HARQ response are transmitted using a PUCCH format 1b, if two transport blocks are detected through the first serving cell and the second serving cell does not include a downlink subframe, which belongs to a downlink subframe set associated with an uplink subframe.

12. The method of claim 9, wherein the HARQ response for the first serving cell is set as a negative acknowledgement (NACK), if neither the PDSCH transmission nor a PDCCH or an EPDCCH indicating the downlink SPS release is detected.
